(19) United States
(12) Patent Application Publication
(10) Pub. No.: US 2016/0055079 A1
(43) Pub. Date: Feb. 25, 2016

(54) SOFTWARE APPLICATION LIFECYCLE MANAGEMENT

(71) Applicant: Rommana Software, LLC, Golden Valley, MN (US)

(72) Inventor: Magdy S. Hanna, San Diego, CA (US)

(21) Appl. No.: 14/466,374

(22) Filed: Aug. 22, 2014

(51) Int. Cl. G06F 11/36; G06N 7/00

(52) U.S. Cl. CPC G06F 11/3692; G06F 11/3684; G06N 7/005

(57) ABSTRACT

In association with a predefined requirement of a software application, a plurality of inputs associated with a scenario that provides a context for the predefined requirement are received, including a scenario name, description, expected behavior, and indicators of a likelihood of the scenario occurring, of an impact of a failure of the scenario, and of a probability of the failure of the scenario occurring. A testing priority is calculated for the scenario based on the indicator of the likelihood of the scenario occurring, the indicator of the impact of the failure of the scenario, and the indicator of the probability of the failure of the scenario occurring. A report that includes the testing priority for the scenario and one or more other testing priorities for one or more other scenarios of the predefined requirement is provided.

### TECHNICAL FIELD

This document generally describes methods, devices and systems for managing the application lifecycle of a software project.

### BACKGROUND

Software developers typically develop software code for a new software application based on a set of software requirements for the software application. Often, the software requirements are provided by a business analyst or by a team of business analysts, and each software requirement is typically a natural language statement that specifies a feature required of the software application.

Before the new software application is released, it is often desirable to test the new software application to verify that it operates as expected. Test engineers create test cases and test scripts that exercise the development code to ensure that the development code operates as expected. Historically, test engineers have developed test cases and test scripts based on the set of software requirements provided by the business analyst or by the team of business analysts.

### SUMMARY

In a first general aspect, a computer-implemented method for software application lifecycle management includes receiving, in association with a predefined requirement of a software application, a plurality of inputs associated with a scenario that provides a context for the predefined requirement. The plurality of inputs includes: i) a scenario name; ii) a scenario description; iii) a scenario expected behavior; iv) an indicator of a likelihood of the scenario occurring; v) an indicator of an impact of a failure of the scenario; and vi) an indicator of a probability of the failure of the scenario occurring. The method also includes calculating, at a computation unit, a testing priority for the scenario based on the indicator of the likelihood of the scenario occurring, the indicator of the impact of the failure of the scenario, and the indicator of the probability of the failure of the scenario occurring. The method further includes providing a report that includes the testing priority for the scenario and one or more other testing priorities for one or more other scenarios of the predefined requirement.

Implementations may include one or more of the following. Calculating the testing priority for the scenario may include associating a first numerical value with the indicator of the likelihood of the scenario occurring, associating a second numerical value with the indicator of the impact of the failure of the scenario, and associating a third numerical value with the indicator of the probability of the failure of the scenario occurring, and computing an average value of the first numerical value, second numerical value, and third numerical value. The method may further include distributing, via an electronic communication, the scenario name, the scenario description, and the scenario expected behavior to one or more users and soliciting one or more responses from the one or more users. The method may further include creating a first test case for the scenario, where the first test case includes one or more first test case inputs, one or more first test case pre-conditions, one or more first test case outputs, and one or more first test case post-conditions. The first test case may be an exploratory test case that is automatically created by assigning the scenario name to an exploratory test case name, assigning the scenario description to an exploratory test case description, assigning the scenario expected behavior to an exploratory test case expected behavior, and providing a test case pass/fail attribute. The method may further include creating a second exploratory test case for the scenario based on the first test case. The method may further include creating a second test case for the scenario, and creating the second test case may include presenting one or more of the first test case inputs and one or more of the first test case pre-conditions, and receiving one or more second test case inputs or pre-conditions that are different from the one or more first test case inputs or pre-conditions, respectively, and receiving one or more second test case outputs or post-conditions that are different from the one or more first test case outputs or post-conditions, respectively. The method may further include creating a third test case for the scenario that is a negative version of the first test case. The predefined requirement may be associated with one or more objects selected from the group consisting of a scenario, a use case, a model, and a test case, and the method may further include creating a second version of the predefined requirement of the software application in response to an approved change request for the predefined requirement of the software application, the second version associated with one or more of the objects. The method may further include associating a model with the predefined requirement, the model selected from the group consisting of a data model, a process model, an object model, a state model, a user interface model, a decision tree, a decision table, and a use case. The method may further include importing the predefined requirement from a word processing application or from a spreadsheet application. The predefined requirement may pertain to a quality aspect of the software application, and the method may further include creating a subcategory of the predefined requirement that pertains to the quality aspect. The method may further include associating a task with the predefined requirement, wherein the task includes a task duration, a task start date, and a task end date. The method may further include providing a graphical representation that shows, for each predefined requirement of a plurality of predefined requirements of the software application, one or more tasks associated with the corresponding predefined requirement, one or more durations for each of the one or more tasks, and an indication of who will perform each of the one or more tasks. The method may further include associating an action or a risk with the predefined requirement. The method may further include providing a report that includes, for the predefined requirement: i) an indication of a percentage of tests that have been completed, and ii) an indication of a percentage of tests that have passed. The predefined requirement may be associated with a plurality of tasks, and the method may further include estimating a cost of the predefined requirement, including computing a cost estimate for each task of the associated plurality of tasks, and providing a report that includes the estimated cost of the predefined requirement and the cost estimate for each task. The method may further include providing a chart that shows, over one or more periods of time, indications of: i) a first number of predefined requirements of the software application that were added; ii) a second number of predefined requirements of the software application that were deferred; iii) a third number of predefined requirements of the software application that were completed; and iv) a fourth number of predefined requirements of the software application that remain to be completed. The method may further include providing a chart that shows, over one or more periods of time, indications of: i) a first number of issues that were added; ii) a second number of issues that were deferred; iii) a third number of issues that were resolved; and iv) and a fourth number of issues that remain. The method may further include providing a user interface that is configurable by a user to display data grids or charts selected by the user. The method may further include providing bidirectional traceability with a third-party issue report software tool. The method may further include providing a user interface that includes a plurality of project activities, wherein the user interface specifies a workflow of the project activities. The method may further include displaying development code constructs associated with the predefined requirement or with the scenario.

In a second general aspect, a computer program product tangibly embodied on a non-transitory computer-readable medium stores instructions that, when executed, cause one or more processors to perform operations including receiving, in association with a predefined requirement of a software application, a plurality of inputs associated with a scenario that provides a context for the predefined requirement, the plurality of inputs comprising: i) a scenario name; ii) a scenario description; iii) a scenario expected behavior; iv) an indicator of a likelihood of the scenario occurring; v) an indicator of an impact of a failure of the scenario; and vi) an indicator of a probability of the failure of the scenario occurring. The operations also include calculating a testing priority for the scenario based on the indicator of the likelihood of the scenario occurring, the indicator of the impact of the failure of the scenario, and the indicator of the probability of the failure of the scenario occurring. The operations further include providing a report that includes the testing priority for the scenario and one or more testing priorities for one or more other scenarios of the predefined requirement.

### BRIEF DESCRIPTION OF THE DRAWINGS

FIG. 1 is a conceptual diagram of an example software development and testing environment that includes a software application lifecycle management tool.

FIG. 2 is a screen shot of an example user interface that may be presented on a display by the software application lifecycle management tool.

FIG. 3 is a screen shot of another example user interface that may be presented on a display by the software application lifecycle management tool.

FIG. 4 is a conceptual diagram of an example scenario.

FIG. 5 is a flow diagram of an example design flow for developing test and development code, and for testing the development code.

FIG. 6 is a screen shot of yet another example user interface that may be presented on a display by the software application lifecycle management tool.

FIG. 7 is a screen shot of yet another example user interface that may be presented on a display by the software application lifecycle management tool.

FIG. 8 is a conceptual diagram of an example test case.

FIG. 9 is a screen shot of yet another example user interface that may be presented on a display by the software application lifecycle management tool.

FIG. 10 is a flow diagram of an example design flow.

FIGS. 11A and 11B are screen shots of example user interfaces that may be presented on a display by the software application lifecycle management tool.

FIG. 12 is a screen shot of yet another example user interface that may be presented on a display by the software application lifecycle management tool.

FIG. 13 is a block diagram that shows examples of models that may be associated with a requirement.

FIG. 14 is a screen shot of yet another example user interface that may be presented on a display by the software application lifecycle management tool.

FIG. 15 is a screen shot of yet another example user interface that may be presented on a display by the software application lifecycle management tool.

FIG. 16 is a screen shot of yet another example user interface that may be presented on a display by the software application lifecycle management tool.

FIGS. 17A and 17B are screen shots of example user interfaces that may be presented on a display by the software application lifecycle management tool.

FIG. 18 is a screen shot of yet another example user interface that may be presented on a display by the software application lifecycle management tool.

FIGS. 19 and 20 are screen shots of example user interfaces that may be presented on a display by the software application lifecycle management tool.

FIG. 21 is an example report that may be presented on a display by the software application lifecycle management tool.

FIGS. 22A, 22B, and 22C are screen shots of example user interfaces that may be presented on a display by the software application lifecycle management tool.

FIG. 23 is a screen shot of an example user interface.

FIG. 24 is a screen shot of another example user interface that may be presented on a display by the software application lifecycle management tool.

FIGS. 25 and 26 are screen shots of example user interfaces that may be presented on a display by the software application lifecycle management tool.

FIG. 27 is a block diagram of an example software application lifecycle tool.

FIG. 28 is a flowchart of an example method that may be performed by a software application lifecycle management tool.

Like reference symbols in the various drawings indicate like elements.

### DETAILED DESCRIPTION

Computing devices that execute software or firmware instructions have become a ubiquitous part of everyday life. On any given day, a person may use or interact with dozens, hundreds, or thousands of computing devices, each of which may include one or more processors that execute software or firmware instructions so that the computing device can perform useful functions. Such computing devices can include any device with one or more processors or computation units, a few examples of which include, without limitation, desktop, laptop, or handheld computers, tablet computing devices, smartphones or other types of mobile phones or communications devices, other mobile computing devices, wearable computing devices, many types of appliances, assorted medical devices or health monitoring devices, security or monitoring systems, home automation or environment systems, vehicle interfaces, enterprise or other business computing systems, entertainment devices (e.g., television, movie, music, video, audio, reading, or gaming devices), and many others.

Many team members and many stages of development and test can be involved in developing and testing the software or firmware, which will generically be referred to as “software” herein. For example, a development engineer or a team of development engineers may develop the software code that will execute on the computing device. A test engineer or a team of test engineers may develop test software (e.g., test cases, test scripts, or both) for testing the development code. Generally, the test cases and test scripts may exercise the development code to confirm that the development code operates as expected, or to identify any problems or issues with the development code if the development code does not operate as expected, so that such problems or issues may be corrected before the development code is released. In various examples, the test cases and test scripts may execute on the same computing device that the development code executes on, or may execute on one or more other computing devices used to test the development code or the computing device and the development code.

A business analyst or a team of business analysts, sometimes also called requirements engineers, may initially create a set of requirements for a to-be-developed software application. Each requirement in the set of requirements for the software application may be in the form of a natural language statement, and may specify a feature that the software application is to include. Historically, development engineers and test engineers would use the set of requirements provided by the business analysts, and would write development code or test cases and test scripts, respectively, based on the set of requirements. However, in many cases such requirements are vague, incomplete, ambiguous, inconsistent, incorrect, or some combination of the foregoing. As such, the development engineers and test engineers can have a difficult time creating the development code or test cases and test scripts with an appropriate level of confidence that the resulting development code or test code will be sufficiently robust, comprehensive, and problem-free.

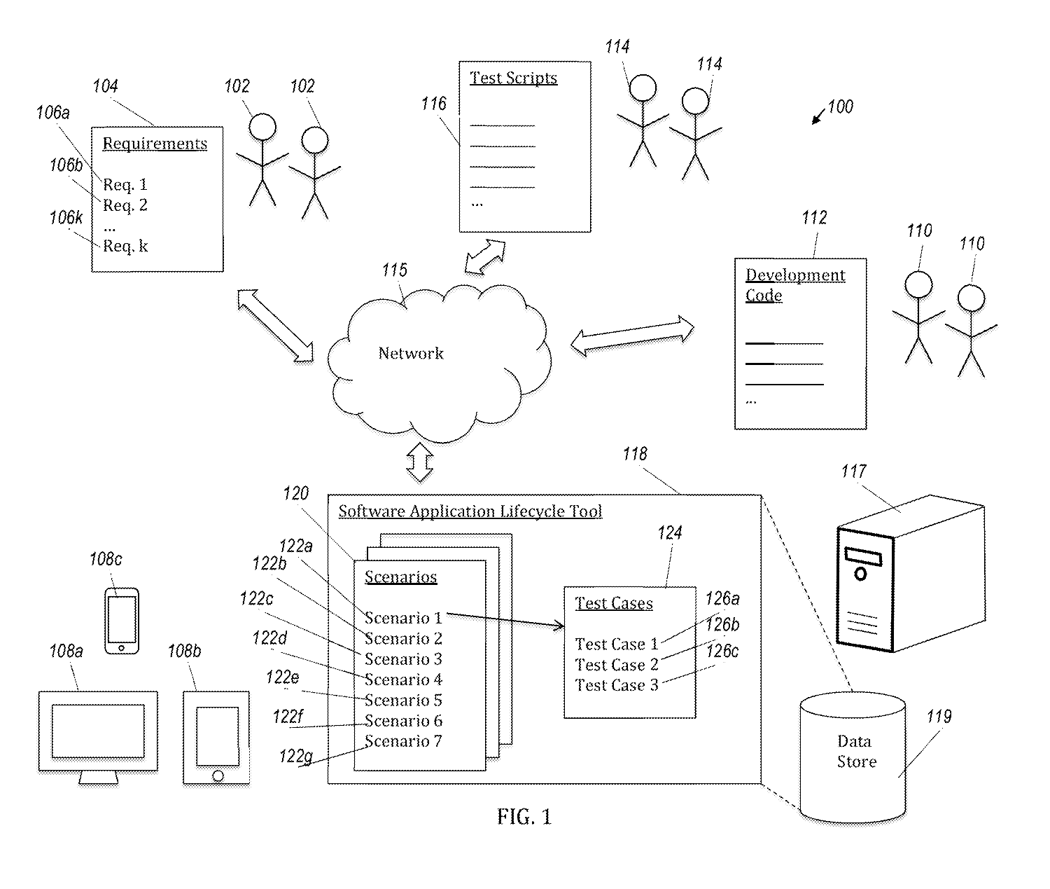

FIG. 1 is a conceptual diagram of an example software development and testing environment 100. One or more business analysts or requirement engineers 102 may develop a set of requirements 104 for a to-be-developed software application, and each of the individual requirements (e.g., requirements 106a, 106b, . . . 106k) of the set of requirements 104 can specify a particular feature that the software application is to include. In some examples, the software application is developed to execute on a particular computing device or type of computing device, or for a particular operating system. In some examples, the operating system may be configured for a particular type of device or for a particular class of device, and in some examples may be configured for a variety of devices or classes of devices. FIG. 1 depicts a small sample of example computing devices that the software application may be developed for, including, without limitation, computer 108a, tablet computing device 108b, and smartphone 108c, and it will be understood that the techniques, devices and systems discussed herein for providing software application lifecycle management may be used for software projects designed for a wide variety of computing devices, including any of those discussed herein above.

Generally, the set of requirements 104 will be determined at the outset of the software development project, but it is not unusual for one or more requirements (e.g., requirement 106k) to be added to the set of requirements 104 after development and/or test of the software application has begun, or even after one or more portions of the software application have been completed. In some examples, each requirement 106 in the set of requirements 104 is in the form of a natural language statement, and specifies a feature that the software application is to include. The set of requirements 104 may be stored in a computer-readable storage medium as a word processing document or as a spreadsheet, according to some examples, or in any other appropriate format. In some examples, the set of requirements 104 may be created or may reside in a requirements management tool (not shown in FIG. 1).

One example of a requirement (e.g., requirement 106a) for the software application may be: “build a web site to receive orders for items A, B, C or D that are placed online by customers.” Such a requirement is a natural language statement, written in English in this example, at a level of detail that is consistent with how one might convey the requirement to another in a casual conversation. The requirement 106a specifies a feature that the software application is to include, namely, that the software application should provide a web site capable of receiving online orders for four different items.

One or more development engineers 110 may create development software code 112 for the software application, and one or more test engineers 114 may create test scripts 116 for testing the development software code 112, or alternatively for testing both the computing device upon which the development software code 112 will execute and the development software code 112. In some examples, a single engineer or team of engineers will create both the development code 112 and the test scripts 116. The examples discussed herein will assume that a dedicated test engineer 114 or team of test engineers is tasked with creating the test scripts 116 for the software application. In some examples, the test engineers 114 will also design or procure test hardware for the testing project.

Team members may use a software application lifecycle management tool 118 to manage one or more aspects of the lifecycle of the software application, including aspects related to design and test of the software application, in some examples. The software application lifecycle management tool 118 may be a computer-implemented tool, for example, and may be used to create, implement and manage various components of the software design and test cycle, to provide an integrated solution that can facilitate more efficient test code designs that provide better test coverage, which may reduce a number of problems or issues associated with the software application, according to some implementations. In some implementations, the software application lifecycle management tool 118A may execute on a server 117. In various implementations, team members (e.g., test engineer 114, development engineer 110, requirements engineer 102) may access the software application lifecycle management tool 118 using a computing device (not shown in FIG. 1) via one or more networks 115, for example, and server 117 may make the software application lifecycle management tool 118 available over the network 115, for example. The server 117 may interface with one or more data stores 119, where one or more portions of the software application lifecycle management tool 118 may reside. Data store 119 may include one or more databases that store information used by the software application lifecycle management tool 118, according to various implementations. While FIG. 1 depicts requirements 104, test scripts 116, and development code 112 outside of the software application lifecycle management tool 118 for illustrative purposes, in some examples one or more of the components 104, 112, 116 may reside within the software application lifecycle management tool 118.

In some examples, the test engineers 114 use the software application lifecycle management tool 118 to manage their testing activities. In some examples, the development engineers 110 use the software application lifecycle management tool 118 to aid development code development and maintenance, and in some examples both the test engineers 114 and development engineers 110 use the software application lifecycle management tool 118. The examples discussed herein will focus on the test engineers 114 using the tool 118 to create, implement and manage the test process for testing the software application being developed as part of the software application development and test process.

In some implementations, the test engineer 114 may use the software application lifecycle management tool 118 to manage aspects related to testing the software application, and may use the tool 118 to create a set 120 of one or more scenarios. Scenarios can be used to support test design and test management. In some examples, each of the individual scenarios (e.g., scenario 122a, 122b, 122c, 122d, 122e, 122f, 122g) may be associated with a requirement (e.g., requirement 106a) of the software application, and may provide a context for the associated requirement. For example, each scenario 122a-g may describe or be associated with a condition, situation, or event that may occur while the software application is operating. The test engineer 114 or another member of the team may use the tool 118 to create the scenarios 122 to further define parameters of the software application, and the scenarios can illuminate aspects of the software application that should be considered during test code development.

As described above, a scenario may be associated with a requirement, and the scenario may bolster the requirement by providing additional information, such as providing context regarding the requirement when considered with respect to a particular condition, situation, or event that may occur while the software application is operating. In some cases, the requirement (e.g., requirement 106a), in the absence of the associated scenarios, may be considered untestable because the requirement by itself may be too vague, ambiguous or incomplete, or may be incorrect or inconsistent with another requirement, for example. The test engineer can use the software application lifecycle management tool 118 to create the set of scenarios 120 so that test code development may proceed as it relates to the associated requirement, for example.

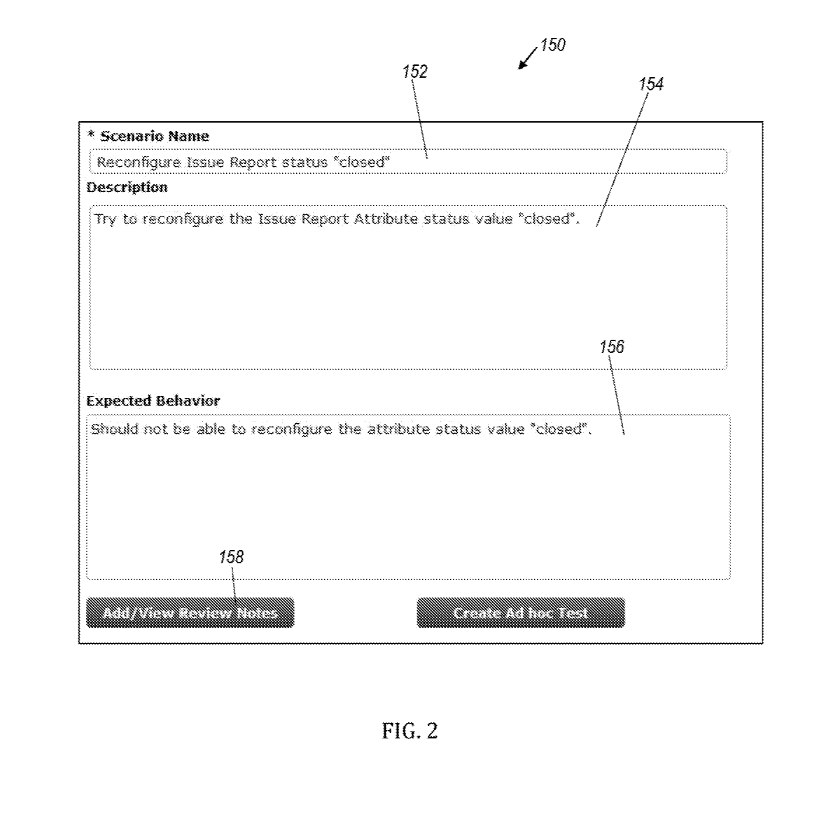

In various implementations, a scenario can include a scenario name, a scenario description, and a scenario expected behavior. FIG. 2 is a screen shot of an example user interface 150 that may be presented on a display by the software application lifecycle management tool 118. The user interface 150 provides a scenario name input field 152, a scenario description input field 154, and a scenario expected behavior input field 156. Each of these fields 152, 154, and 156 can be used by the test engineer 114 (or another member of the team) to define the scenario, and software application lifecycle management tool 118 can receive the inputs via the user interface 150. In some implementations, the interface 150 may be arrived at from a user interface relating to a particular requirement, for example, and the user may select to create a scenario for the requirement, and be presented with interface 150.

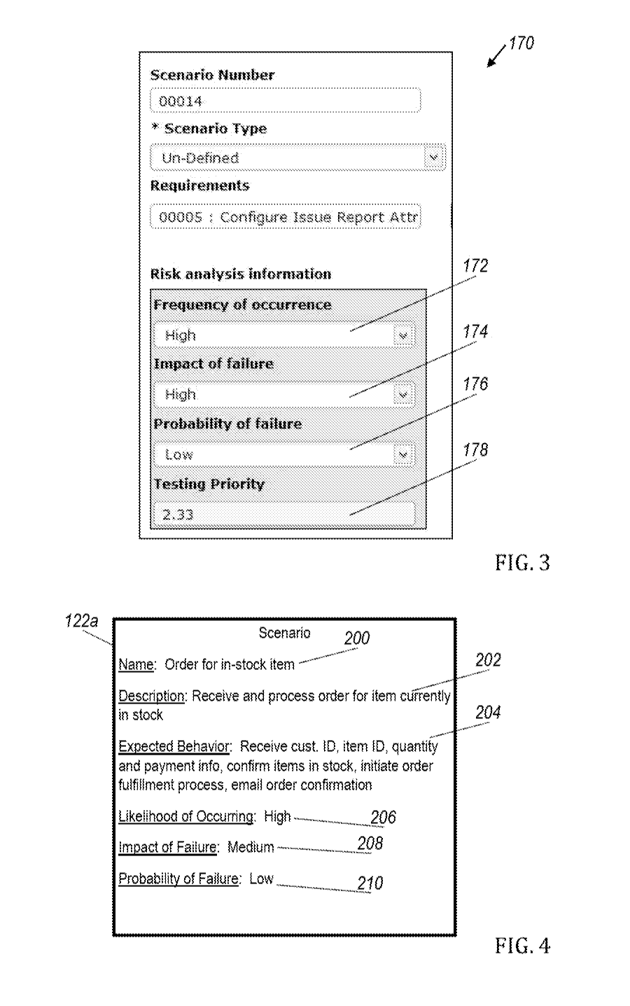

In some examples, the scenario 122 can also include information for risk analysis, including one or more of an indicator of a likelihood of the scenario occurring, an indicator of an impact of a failure of the scenario, and an indicator of a probability of the failure of the scenario occurring. Risk analysis at the scenario level can be useful for prioritizing test development, as will be further explained below. FIG. 3 is a screen shot of an example user interface 170 that may be presented on a display by the software application lifecycle management tool 118. For a given scenario (e.g., scenario “00014” in the FIG. 3 example), a user (e.g., a test engineer 114) can use the interface 170 to enter a likelihood of the scenario occurring indicator 172 (“High” in this example, alternatively titled “Frequency of occurrence” here), an impact of a failure of the scenario indicator 174 (“High” in this example), and a probability of the failure of the scenario occurring indicator 176 (“Low in this example). In some examples, the indicators 172, 174 and 176 may be considered attributes of the scenario. The software application lifecycle management tool 118 may receive the inputs, and associate them with the corresponding indicators or attributes of the scenario.

The likelihood of the scenario occurring indicator 172 provides an indication of how often or how frequently the scenario is expected to occur during operation of the software application. In some examples, the indicator 172 may have a value of “high,” to indicate that the scenario may occur relatively frequently or be relatively likely to occur, “medium” to indicate that the scenario may occur with an average or typical frequency, or “low” to indicate that the scenario may occur relatively infrequently or be relatively unlikely to occur.

The impact of a failure of the scenario indicator 174 provides an indication of how problematic it would be, or how adverse the impact of a failure would be, for the software application to fail when the scenario occurs during operation of the software application. In some examples, the indicator 174 may have a value of “high,” to indicate that a failure would be extremely problematic or have a high adverse impact, “medium” to indicate that a failure would have average adverse impact, or “low” to indicate that a failure would be have relatively lower adverse impact.

The probability of the failure of the scenario occurring indicator 176 provides an indication of how likely the scenario is to fail, should the scenario occur during operation of the software application. In some examples, the indicator 176 may have a value of “high,” to indicate that the scenario may be relatively likely to fail if the scenario occurs, “medium” to indicate that the scenario may fail with an average likelihood if the scenario occurs, or “low” to indicate that the scenario may be relatively unlikely to fail if the scenario occurs.

For the example requirement 106a discussed above with reference to FIG. 1 and relating to the online order web site, an example scenario 122a may describe an event whereby a user uses the web site to place an order for an item (e.g., item A) that is currently in inventory. FIG. 4 is a conceptual diagram of an example scenario (e.g., the scenario 122a of FIG. 1). The scenario 122a includes a name 200 (“Order for in-stock item” in this example), a description 202 (“Receive and process order for item currently in stock” in this example), and an expected behavior 204 (“Receive customer ID, item ID, quantity and payment information, confirm items in stock, initiate order fulfillment process, and email order confirmation” in this example). The scenario 122a also includes a likelihood of the scenario occurring attribute 206 (“High” in this example), an impact of a failure of the scenario attribute 208 (“Medium” in this example), and a probability of the failure of the scenario occurring attribute 210 (“Low” in this example). In some examples, the scenario 122a also includes a requirement attribute (not shown) that identifies the requirement (e.g., requirement 106a) that the scenario 122a is associated with.

In practice, a test engineer 114 may create several, dozens, or even hundreds of scenarios, depending on the requirement. Ideally, the test engineer 114 will have sufficient time and resources to fully test the development code according to each of the scenarios. Often, however, a reality with many testing projects is that the test engineer 114 is not given sufficient time or resources to fully test each of the scenarios.

In some examples, the software application lifecycle management tool 118 may compute a testing priority for the scenario, or for each scenario in a group of scenarios. The testing priority can provide an indication of a relative importance for testing a scenario. In situations where fully testing each of the scenarios may not be possible, computed scenario testing priorities can inform the test engineer of those scenarios (e.g., those scenarios with relatively higher computed testing priorities) that he/she should be sure to fully test, and of those scenarios (e.g., those scenarios with relatively lower computed testing priorities) that may be less important to fully test, given the constraints of the project. With this information, the test engineer may be better able to create a more effective test development and implementation strategy when difficult choices must be made due to scheduling constraints, fiscal constraints, personnel bandwidth constraints, delays from within or outside of the test department, or other constraints.

In some examples, numerical values may be associated with each of the likelihood of the scenario occurring indicator 172, the impact of a failure of the scenario indicator 174, and the probability of the failure of the scenario occurring indicator 176. For example, a value of 1.0 may be associated with attributes having a “low” value; a value of 2.0 may be associated with attributes having a “medium” value; and a value of 3.0 may be associated with attributes having a “high” value. In other examples, alternative numerical values can be used. For example, a numerical value higher than 3.0, such as 4.0, 5.0, 6.0, or other appropriate number can be used for indicators or attributes with a “high” value, to emphasize the importance of testing scenarios with risk-analysis attributes having “high” values.

In some examples, the testing priority for the scenario may be computed as an average value (e.g., a mean value) of the three numerical values. As can be seen with reference again to FIG. 3, a testing priority 178 of 2.33 has been computed, where 2.33=(3.0+3.0+1.0)/3, corresponding to the mean value of the values associated with the indicators 172, 174, and 176, as discussed above. In this manner, the software application lifecycle management tool 118 may provide risk-analysis information at the scenario level, which is different from risk-analysis information at the requirement level or project level, by contrast. The software application lifecycle management tool 118 may compute a testing priority based on the likelihood of the scenario occurring indicator 172, the impact of a failure of the scenario indicator 174, and the probability of the failure of the scenario occurring indicator 176.

In some examples, the testing priority may be computed by using a weighted average value, where calculation of the priority includes multiplying one or more of the indicators by a weighting factor other than 1.0. For example, one or more of the risk indicators may be associated with a weighting factor other than 1.0 (e.g., without limitation, 0.5, 0.75, 1.25, 1.5, 1.75, 2.0, 2.25, 2.5, 2.75, 3.0). As one example, the likelihood of the scenario occurring indicator 172 may be associated with a weighting factor of 0.75, the impact of a failure of the scenario indicator 174 may be associated with a weighting factor of 2.0, and the probability of the failure of the scenario occurring indicator 176 may be associated with a weighting factor of 1.5. In this example then, using the values for the indicators discussed above, a weighted average calculation of the testing priority may be 3.25=(0.75*3.0+2.0*3.0+1.5*1.0)/3, and the tool 118 may calculate the weighted average in this manner to determine a testing priority for one or more (e.g., all) of the scenarios.

In some examples, a median value may be used to calculate the testing priority rather than a mean value. In some examples, a mode value may be used to calculate the testing priority. In some examples, numerical calculations other than those described above may be used to compute the testing priority for the scenario.

With reference again to FIG. 1, other examples of scenarios that may be created for the example requirement 106a relating to the online order web site can include: i) a second scenario 122b that describes a user placing an order for an item (e.g., item B) that is not currently in inventory; ii) a third scenario 122c that describes a user places an order for delivery to an address that is outside of the United States; iii) a fourth scenario 122d where a user places an order for delivery to a post office box; iv) a fifth scenario 122e where a user places an order and pays using a credit card; v) a sixth scenario 122f where a user places an order and pays using an online payment processing vendor; vi) a seventh scenario 122g where a user places an order, where a portion of the ordered product is currently in inventory and a portion of the ordered product is not currently in inventory. In various implementations, each of these scenarios 122b-g may include a scenario name, description, expected behavior, and likelihood of the scenario occurring, impact of a failure of the scenario, and probability of the failure of the scenario occurring attributes.

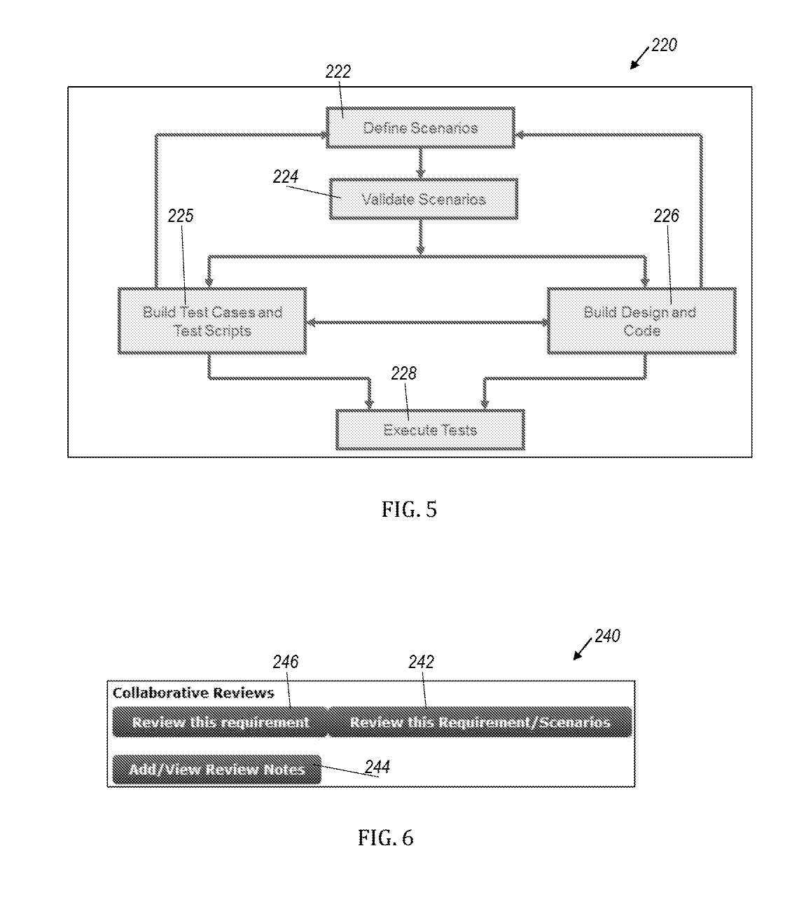

FIG. 5 is a flow diagram of an example design flow 220 for developing test and development code, and for testing the development code. At step 222, one or more scenarios are defined using the software application lifecycle management tool 118, as discussed above with reference to FIGS. 2-3. At step 224, the scenarios defined at step 222 are validated using the software application lifecycle management tool 118, as will be further described below with reference to FIG. 6. At step 225, one or more test engineers 114 use the software application lifecycle management tool 118 to build test cases and test scripts based on the scenarios, as will be further described below with reference to FIGS. 1, 8 and 9. At step 226, one or more development engineers 110 use the software application lifecycle management tool 118 to write development code 112 based on the scenarios. In some examples, the development engineers 110 may use validated scenarios from the tool 118 to develop the development code 112. As can be seen in FIG. 5, the scenarios can benefit both the test engineers and the development engineers, at steps 225 and 226, respectively, and these steps can proceed in parallel in some implementations. At step 228, the test engineers 114 execute the tests, using the test scripts 116 to test the development code 112.

Regarding validating the scenarios, in some examples after the test engineer 114 or other team member creates a scenario 122, he or she may use the software application lifecycle management tool 118 to circulate the scenario 122 for review to members of the software project team (e.g., to one or more other test engineers 114, to one or more business analysts 102, to one or more development engineers 110, to one or more managers or supervisors, or to other members of the organization), or in some cases even to certain customers. For example, the test engineer 114 may use the software application lifecycle management tool 118 to circulate, via email or other appropriate communication method, the scenario 122 along with an invitation to review and comment on the scenario 122. Recipients of the invitation may use the software application lifecycle management tool 118 to review the scenario 122 and provide comments on the scenario 122. In some implementations, the software application lifecycle management tool 118 may store the communications for historical reference.

FIG. 6 is a screen shot of an example user interface 240 that may be presented on a display by the software application lifecycle management tool 118. In some examples, the interface 240 can be used to facilitate a collaborative review of one or more scenarios. For example, a user may select the “Review this Requirement/Scenarios” button 242 to cause an email (or other appropriate communication, such as instant message, text message, phone call, or the like) to be sent to predefined team members requesting a review and validation of the one or more scenarios. In some examples, the scenarios may be reviewed and validated in the context of the associated requirement. Recipients may receive the email and use the tool 118 to review the one or more scenarios, for example in the context of the associated requirement. In some examples, the recipients may use the tool 118 to provide feedback on the one or more scenarios, for example by selecting button 244 (or alternatively, by selecting button 158 in the interface 150 of FIG. 2) and providing feedback. In some examples, the tool 118 stores the comments, and may make them available to other team members (in some examples generating another email to alert them to the availability of comments), to provide an historical record of discussions or comments related to the scenarios. For example, when feedback is received from a team member, an email may be circulated to other team members informing them that feedback is available for review. Requirements may be reviewed in a similar manner, and such review may be initiated by selection of button 246, for example.

By facilitating collaborative review of scenarios, as discussed above, the tool 118 can accommodate team members at disparate locations, perhaps even in different time zones. This may eliminate a need for in-person meetings, for example, as team members may review and comment at their convenience. Also, communication and collaboration may be encouraged between team members, which may lead to tighter integration between the development team and test team, for example, and may result in a higher quality software application and test coverage, according to some implementations.

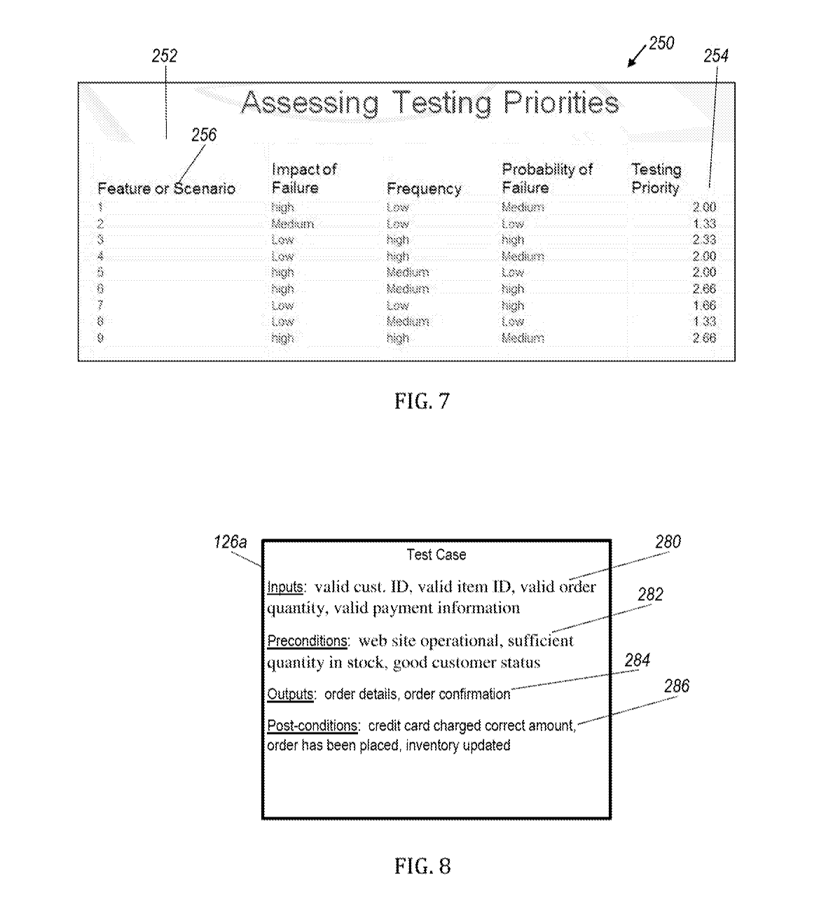

As described above, the software application lifecycle management tool 118 can compute a testing priority for a scenario for risk analysis assessments, based on several risk analysis indicators or attributes. In some examples, the tool 118 can present a report that includes the computed testing priorities of a plurality of scenarios. FIG. 7 is a screen shot of an example user interface 250 that may be presented on a display by the software application lifecycle management tool 118. The interface 250 includes a report 252 that includes computed testing priorities 254 (a column of nine testing priorities in this example) for a collection of scenarios 256 (a collection of nine scenarios in this example). In some examples, each of the scenarios and testing priorities in the report may pertain to scenarios that are associated with the same requirement. In some examples, the report may provide scenarios and associated testing priorities that correspond to more than one requirement. In some examples, the scenarios may be sorted based on testing priority value. In the depicted example of FIG. 7, the report also includes, for each scenario, the risk analysis indicators or attributes, including the impact of failure indicator, the likelihood of the scenario occurring indicator, and the probability of the failure occurring indicator.

Using the comparative information in the report 252, including the testing priorities 254 that may be automatically computed by the software application lifecycle management tool 118, a test engineer 114 or test manager can better decide which scenarios should be fully tested, or tested first, based on the time and/or resources available to the test team. Risk assessment information at the scenario level may be more useful than risk assessment information at the requirement level, in some examples, because requirements are typically written at a high level and, as a result, risk assessment information at the requirement level may be less accurate than risk assessment information at the scenario level.

With reference again to FIG. 1, when the determination has been made regarding which scenario (e.g., scenario 122a) to test, the test engineer 114 can use the software application lifecycle management tool 118 to create one or more test cases 124 for the scenario 122a. Each of the one or more individual test cases (e.g., test case 126a, test case 126b, test case 126c) may be associated with a particular scenario. In the depicted example, the test cases 126a, 126b, and 126c are all associated with scenario 122a, and are created based on the scenario 122a to test the scenario 122a.

FIG. 8 is a conceptual diagram of an example test case (e.g., the test case 126a of FIG. 1). The test case 126a in this example includes four components: i) one or more test case inputs 280, one or more test case pre-conditions 282, one or more test case outputs 284, and one or more test case post-conditions 286. The test case inputs 280 may generally specify inputs that can be received, and in this example are “valid customer ID,” “valid item ID,” “valid order quantity,” and “valid payment information.” The test case preconditions may generally specify prevailing conditions at the time the test case inputs are received, and in this example are “web site operational,” “sufficient quantity in stock,” and “good customer status.” The test case outputs 284 are generally outputs expected to be provided by the software application when the test is executed, and in this example are order details and an order confirmation. The test case post-conditions 286 may generally describe conditions expected to exist after the test is executed, and in this example are a credit card being charged a correct amount, placement of the order, and inventory updated to reflect the amount ordered. In some examples, one or more of the post-conditions correspond to one or more of the pre-conditions, and in particular specify how the conditions are expected to change based on the test. In some examples, the post-conditions correspond to conditions different from the conditions associated with the preconditions. Test cases may also include a test case number, title, description, and status, each of which is not shown in FIG. 8. In general, test cases 126 may include the following relationship regarding the four components 280, 282, 284 and 286 of the test cases: Inputs (280)+Preconditions (282) YIELD Outputs (284)+Post-Conditions (286).

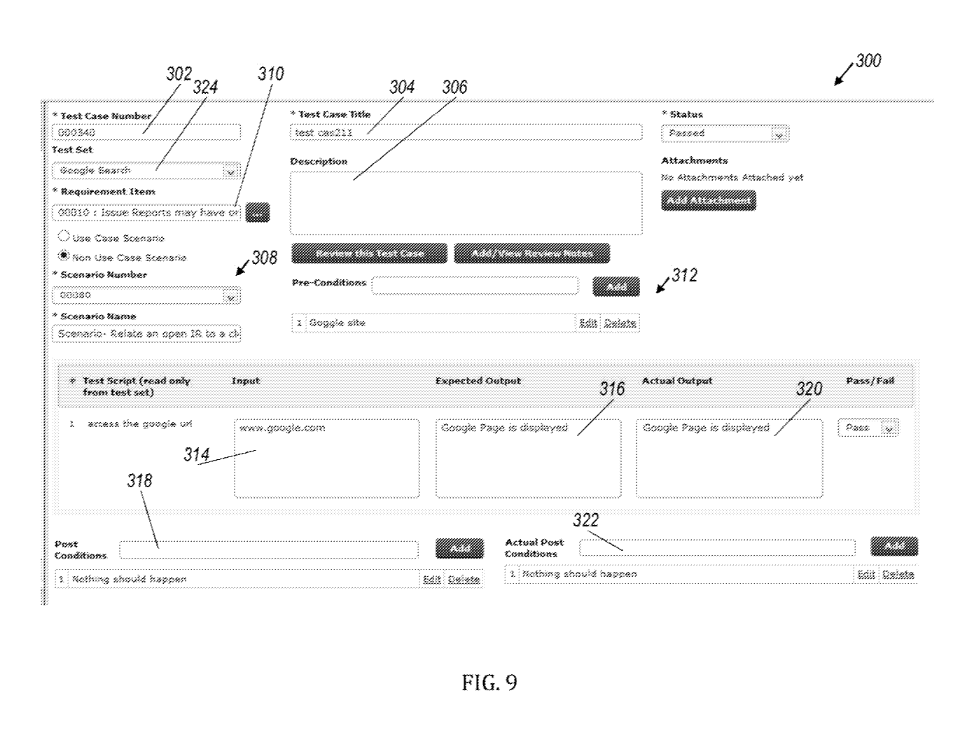

FIG. 9 is a screen shot an example user interface 300 that may be presented on a display by the software application lifecycle management tool 118. A test engineer 114 may use the interface 300 to define or create a test case for a scenario. The interface 300 includes fields for specifying a test case number 302, a test case title 304, a test case description 306, the associated scenario 308 to be tested and the requirement 310 that the scenario 308 is associated with. The interface 300 further includes fields for specifying preconditions 312, inputs 314, expected outputs 316 and expected post-conditions 318. In some examples, fields for actual outputs 320 and actual post-conditions 322 are provided.

Often, a test engineer will want to create several, dozens, or hundreds of test cases to test a given scenario. In some examples, the software application lifecycle management tool 118 can facilitate test set creation by presenting (e.g., on a display) one or more of a first test case inputs and/or pre-conditions, and optionally one or more of the first test case outputs and post-conditions. The test engineer can view the components of the first test case, and consider changes to the inputs or preconditions to define a second test case. For example, a second test case may be created by altering one or more of the first test case inputs or preconditions, and then updating the expected output and post-conditions based on the altered inputs or preconditions, if applicable. The tool 118 may then receive one or more input or pre-condition inputs that are different from the presented one or more first test case inputs or pre-conditions, as well as the updated outputs and post-conditions if they are expected to change given the new inputs or preconditions. In this manner, a large number of test cases may be created relatively quickly, which can facilitate improved test coverage in some implementations.

In some examples, each of the test cases designed to test a particular scenario may be grouped together into a scenario-based test set. With reference again to FIG. 1, the test cases 124 may be considered a scenario-based test set, as each of the individual test cases 126a, 126b, and 126c pertain to the same scenario (scenario 122a in this example). With reference now to FIG. 9, interface 300 includes a field 324 for specifying a test set for the test case.

In some examples, test sets may be formed to include test cases that pertain to more than one scenario. For example, a requirement-based test set may include, for each of the scenarios that correspond to a particular requirement, all of the test cases that correspond to each of the scenarios for the requirement.

In some examples, the software application lifecycle management tool 118 can automatically create a test case, which may be referred to as an exploratory test case or ad hoc test, based on a scenario. For example, for scenarios that have a computed testing priority less than, or less than or equal to, a predetermined threshold testing priority value, the tool 118 may automatically create an exploratory test case for the scenario. In some examples, the tool 118 may automatically create an exploratory test case for the scenario based on a request from the test engineer, for example. The tool 118 may assign the scenario name to an exploratory test case name, may assign the scenario description to an exploratory test case description, and may assign the scenario expected behavior to an exploratory test case expected behavior. The tool 118 may also create a pass/fail attribute for the exploratory test case. Automatically creating exploratory test cases for certain scenarios may help to promote better test coverage, according to some implementations. For example, scenarios that may otherwise go untested, due to project constraints and due to higher priorities associated with other scenarios, may now be tested using the exploratory test cases, in some examples. A test engineer may also add other exploratory or ad hoc tests in addition to those automatically generated or created by the tool. For example, the test engineer may provide a title, description, and expected result.

Because requirements have historically been framed in a positive context, such as “the application must perform task X,” development engineers and test engineers have been much more likely to write development code and test code, respectively, to handle the positive aspect of the requirement. By contrast, error-handling code is code that development engineers write to handle error conditions that occur while the software is operating, such as for an invalid data input or when the system encounters extreme or abnormal conditions, or when a user tries to force the system to perform an operation it is not supposed to perform, or a user tries to perform an operation he or she is not supposed to perform. Requirements typically have not mentioned such error conditions.

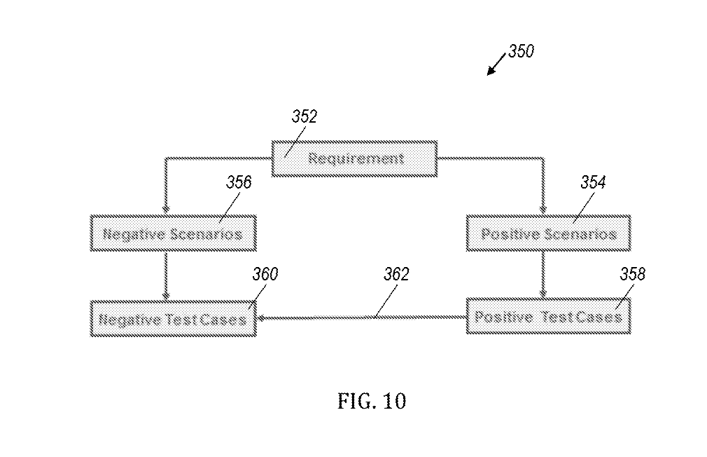

FIG. 10 is a flow diagram of an example design flow 350. Historically, test engineers have had a tendency to think about “negative” testing for testing handling of error or abnormal conditions only after they have completed “positive” testing for performance of the normal or standard operating tasks required of the software application. Given the scheduling or resource constraints that often accompany testing projects, this has historically resulted in an inadequate amount of negative testing.

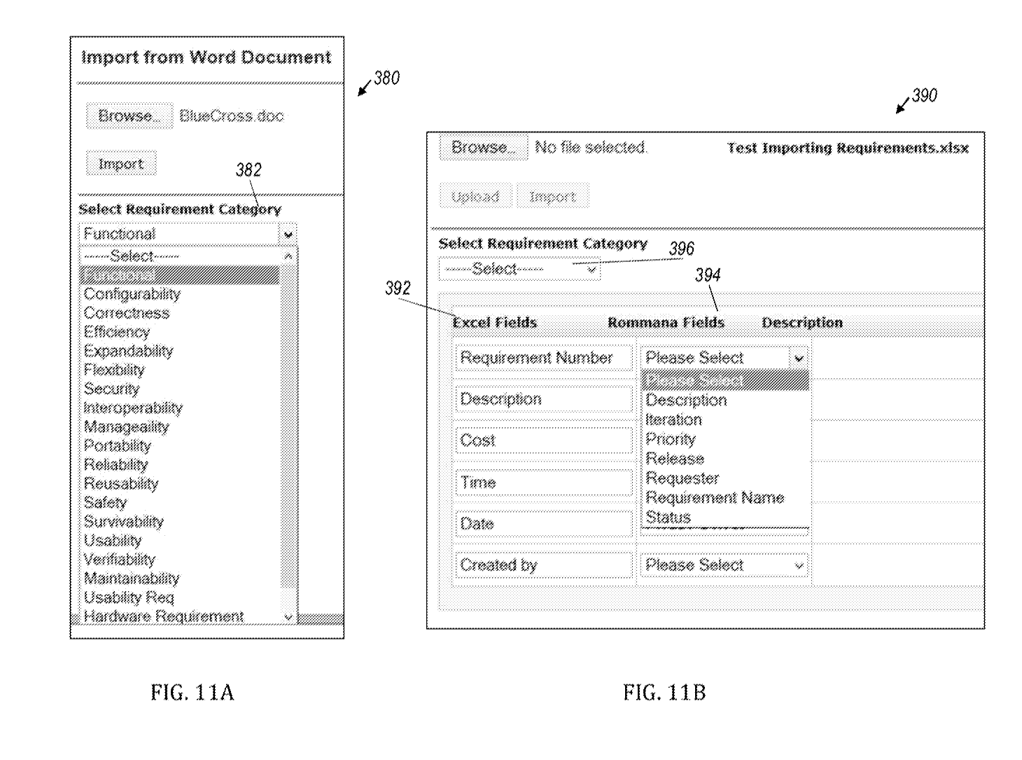

In some examples, the software application lifecycle management tool 118 can facilitate the development of negative testing constructs, which can result in better test coverage and more robust systems. The process starts at step 352 with a requirement being provided to the tool 118 or imported to the tool 118 (as will be described below with reference to FIG. 11), as by entering in an input field specifying for upload or entering the requirement into the tool 118, for example. The requirement may be in the form of a natural language statement, for example. At step 354, one or more positive scenarios are created. The one or more positive scenarios may be associated with the requirement, for example, or written for the requirement. One or more negative test scenarios may be created at step 356 for the requirement, and this may occur in parallel with or near the same time as the positive scenarios are created, or at a different time, according to various implementations. For each of the positive scenarios created at step 354, one or more positive test cases may be created at step 358, based on the positive scenario and designed to test the positive scenario. Similarly, for each of the negative scenarios created at step 356, one or more negative test cases may be created at step 360, based on the negative scenario and designed to test the negative scenario.

In some implementations, one or more additional negative test cases can be created 362 based on one or more of the positive test cases created at step 358. For example, the tool 118 may present (e.g., on a display) the positive test case and suggest that a negative test case be created by modifying one or more inputs of the positive test case, or by modifying one or more preconditions of the positive test case. A user (e.g., a test engineer) may make one of the suggested modifications to an input or precondition, for example, and may then modify one or more outputs or post-conditions for the test case, based on how the modified input or precondition should affect the expected outputs or post-conditions.

In some examples, the tool 118 may modify an input or precondition of a positive test, and may present (e.g., on a display) the modified set of inputs and preconditions as a potential negative test case based on the positive test case, and may ask the user if he or she would like to continue specifying the negative test case, as by modifying one or more of the expected outputs or expected post-conditions. The user may accept the proposed negative test case, for example, and may optionally update the outputs or post-conditions. As one example, for an example positive test case that includes a “receive valid credit card” input, the tool 118 may propose a negative test case, based on the example positive test case, with a “receive invalid credit card,” or “do not receive valid credit card” input. As another example, for an example positive test case that includes a “customer in good standing” precondition, the tool 118 may propose a negative test case, based on the example positive test case, with a “customer not in good standing” precondition. As the examples illustrate, the tool 118 may negate or provide an inverse of an input or precondition of a positive test case, which may serve, along with the other inputs and preconditions of the positive test case, as a proposed negative test case based on the positive test case or as a template for a negative test case based on the positive test case. In some cases, the tool-suggested input or precondition modification may be unrealistic, for example, and the user may select to delete the proposed negative test case.

As described above, it is common for requirements to be stored in a word processing document or in a spreadsheet document. In some cases, hundreds or thousands of requirements may be stored in such a document, for example. In some examples, the software application lifecycle management tool 118 can import requirements from a word processing document (e.g., a Microsoft Word document) or from a spreadsheet document (e.g., a Microsoft Excel document) into the software application lifecycle management tool 118. For example, a user may add one or more Meta tags (or symbols) to the word processing document to identify a requirement title and/or a requirement description, to prepare the word processing document for the importation process. The user may do this for each of the requirements in the document, for example. The software application lifecycle management tool 118 may then import the tagged requirement titles and requirement descriptions into the tool 118 and create a requirement object with the title and description attributes. The tool 118 may assign the imported requirement a unique requirement identifier. In some examples, the tool 118 may assign default values to one or more other requirement attributes, for example. If desired, a user may change values for any of the default values at a later time.

FIG. 11A is a screen shot of an example user interface 380 that may be presented on a display by the software application lifecycle management tool 118 when importing one or more requirements from a word processing document, for example. A user can specify a document, and can then select a requirement category 382 to which the imported requirement or requirements pertain.

FIG. 11B is a screen shot of an example user interface 390 that may be presented on a display by the software application lifecycle management tool 118 when importing one or more requirements from a spreadsheet document, for example. A user may specify the spreadsheet, and may map a column of the spreadsheet 392 (labeled “Excel Fields” in the interface 390) to a predefined requirement attribute 394 in the tool 118, and select a requirement category 396. In some examples, the tool 118 may create custom requirement attributes for those spreadsheet columns that were not mapped to a predefined requirement attribute, and may assign a default value to attributes that lack values in the spreadsheet. For each row of the spreadsheet, the tool 118 may create a requirement, in some examples.

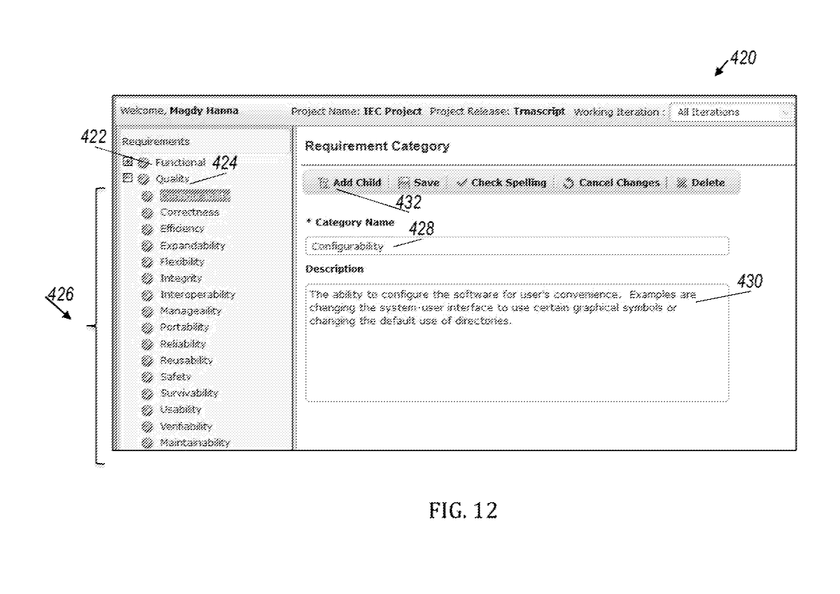

Historically, requirements have typically been conveyed as functional requirements, each of which specifies a function that the system is to perform. Quality requirements, in contrast to functional requirements, pertain to a quality aspect of the software application, and define how well the system performs its functions. Some examples of quality requirements categories include system security, system ease of use, system response time, and system safety. In addition to providing for functional requirements, the software application lifecycle management tool 118 provides for quality requirements, and provides a collection of quality requirement sub-categories. FIG. 12 is screen shot of an example user interface 420 that may be presented on a display by the software application lifecycle management tool 118. The interface 420 shows that the tool 118 handles functional requirements 422 and quality requirements 424. Under quality requirements 424, the tool includes sixteen quality requirement sub-categories 426 to provide guidance to the project team to define quality requirements under each of the quality requirement sub-categories 426. As can be seen in FIG. 12, individual quality requirement sub-categories include: Configurability, Correctness, Efficiency, Expandability, Flexibility, Integrity, Interoperability, Manageability, Portability, Reliability, Reusability, Safety, Survivability, Usability, Verifiability, and Maintainability. For the selected sub-category “Configurability,” 428, a description 430 is provided to encourage the project team to define quality requirements, as by selecting the “Add Child” button 432 to create a new Configurability quality requirement. If a user desires, additional quality requirement sub-categories can be added, or the names or description of existing quality requirement sub-categories can be altered. In some examples, one or more quality requirement sub-categories may be deleted.

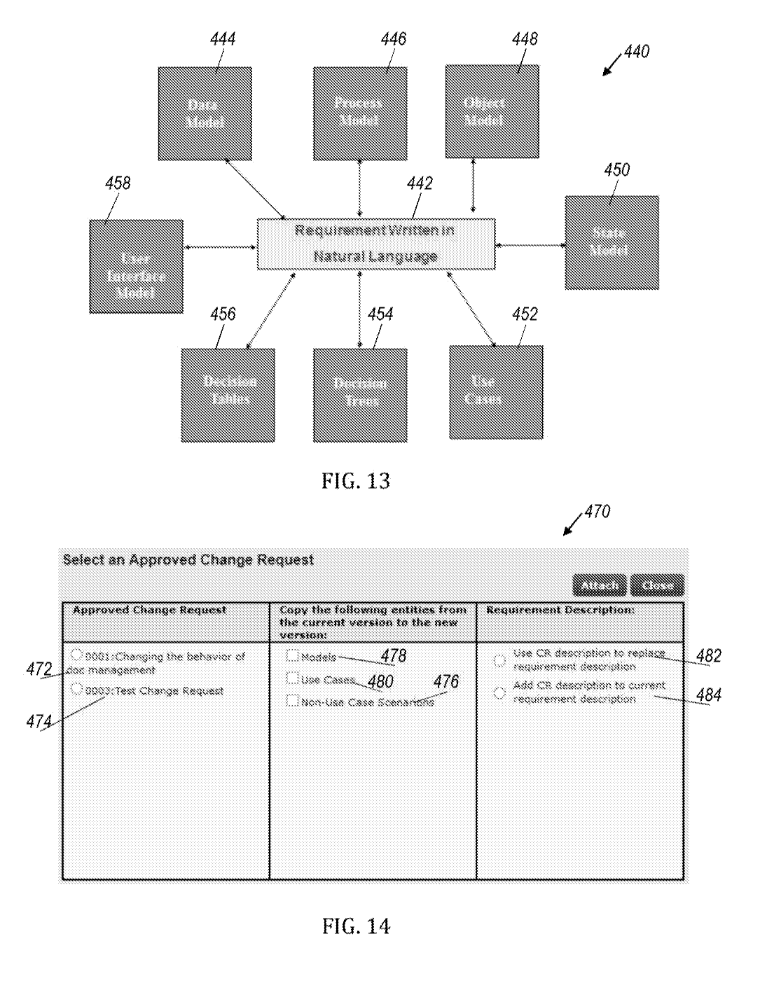

In some examples, it may be difficult or burdensome to communicate a requirement using a natural language statement. In some implementations, the software application lifecycle management tool 118 permits a user to associate a model with a requirement, where the model can provide additional details relating to the requirement. Examples of model types that may be associated with an existing requirement (e.g., in the form of a natural language statement) can include, without limitation, a data model, a process model, an object model, a state model, a user interface model, a decision tree, a decision table, and a use case. FIG. 13 is a block diagram 440 that shows examples of models that may be associated with a requirement. For a given requirement 442, which in some examples may be in the form of a natural language statement, one or more of a data model 444, process model 446, object model 448, state model 450, use case 452, decision tree 454, decision table 456, or user interface model 458 may be associated with the requirement 442. In this manner, a requirement may be specified with more particularity, as the one or more models may better define the requirement and provide additional details. The tool 118 may facilitate circulating of the requirements 442 and one or more of models 444-458 for collaborative review and comment in a similar manner as scenarios can be circulated, as described above with reference to FIG. 6. In some examples, a user may add new model types or may remove a model from the project if not relevant to the project. In some examples, a user may change a model associated with a requirement and may upload a new model file.

Occasionally, a member of the requirements team or other team member will request a change to an existing requirement. The software application lifecycle management tool 118 may maintain different versions of the same requirement, for example, which may permit a first group to work on a first version of the development code or test code (e.g., for a current release) according a first version of the requirement, and may permit a second group to work on a second version of the development code or test code (e.g., for a future release) according to a second version of the requirement. In various implementations, one or more aspects of the requirement may be carried through from the first version of the requirement to the second version of the requirement. For example, if a scenario is associated with a first version of the requirement, the scenario may also be associated with the second version of the requirement. Similarly, if a use case or a model is associated with a first version of the requirement, the use case or the model may also be associated with the second version of the requirement, according to some implementations. In some examples, a first version of a predefined requirement is associated with one or more objects, such as one or more scenarios, use cases, models, or test cases, and the tool 118 may create a second version of the predefined requirement in response to an approved change request, where the second version is associated with one or more of the objects.

FIG. 14 is a screen shot of an example user interface 470 that may be presented on a display by the software application lifecycle management tool 118. In some examples, the tool 118 may permit only change requests that have been approved to be processed for creation of a new version of the requirement. The interface 470 shows two approved change requests 472 and 474, and a user may select one of them. The user may then choose to copy one or more scenarios 476, models 478, or use cases 480 associated with the first version of the requirement to the to-be-created second version of the requirement. Regarding description of the new version of the requirement, the user may select to have the change request description of the requirement replace the description of the earlier version of the requirement 482, or to have it supplement the description by adding it to the new version of the requirement 484. In some examples, the tool 118 will attach the selected approved change request to an existing requirement. In some examples, the tool 118 checks to be sure that the existing requirement has a status of either baselined or implemented, in order to create a new version based on an approved change request.

In some examples, the software application lifecycle management tool 118 facilitates associating actions, risks, or tasks with specific requirements. This may permit the associated action, risk or task to be tracked along with the requirement. Further, actions may be related to one or more requirements, risks may be related to one or more requirements, or tasks may be related to one or more requirements.

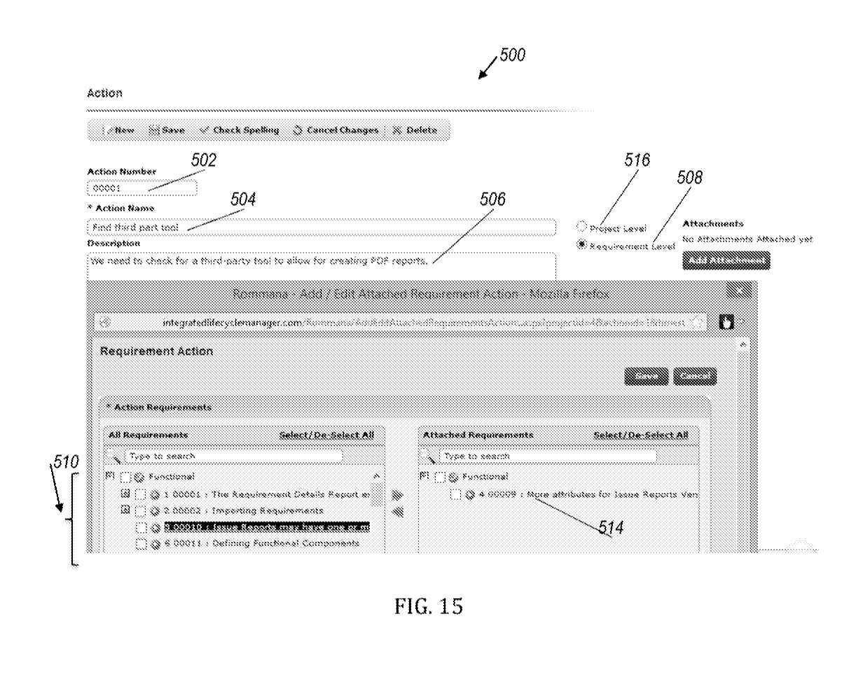

In particular, the tool 118 may permit an action, risk, or task to be associated with a particular requirement, as opposed to being merely associated with a project. FIGS. 15, 16, 17A and 17B are screen shots of example user interfaces 500, 530, 560 and 590, respectively, that may be presented on a display by the software application lifecycle management tool 118. A user may use the interface 500 of FIG. 15 to define an action associated with a requirement, for example. The interface 500 provides fields for an action number 502, and action name 504, and an action description 506. As can be seen in FIG. 15, the action is defined at the requirement level 508. A user can use the interface 500 to view a list of all of the requirements 510, and select one or more requirements from the list to associate or attach the action to. In the depicted example, the user has associated a “Find third-party tool” action with a particular requirement 514. In some examples, the tool 118 permits a user to assign an action to a team member, assign a date by which the action should be completed, and update a status of the action. In other examples, an action can be defined at the project level 516.

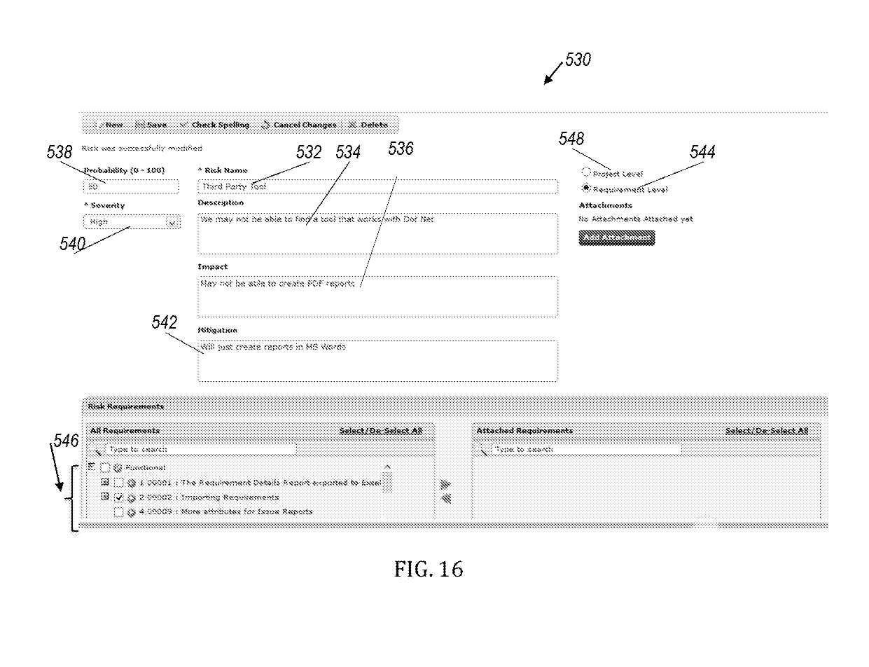

A user may use the interface 530 of FIG. 16 to define a risk associated with a requirement, for example. The interface 530 provides fields for a risk name 532, a risk description 534, an impact 536 the risk may have on the associated requirement, a probability 538 of the risk occurring, a severity 540 of the risk, and a mitigation strategy 542. As can be seen in FIG. 16, the risk is defined at the requirement level 544. A user can use the interface 530 to view a list of all of the requirements 546, and can select one or more requirements from the list to associate or attach the risk to (none shown as attached in FIG. 16). In some implementations, associating risks with requirements may permit a user to better assess the feasibility or likelihood that a particular release will be completed on schedule, for example, based on one or more of the risk's probability 538, severity 540, impact 536, and mitigation strategy 542. In other examples, a risk can be defined at the project level 548.

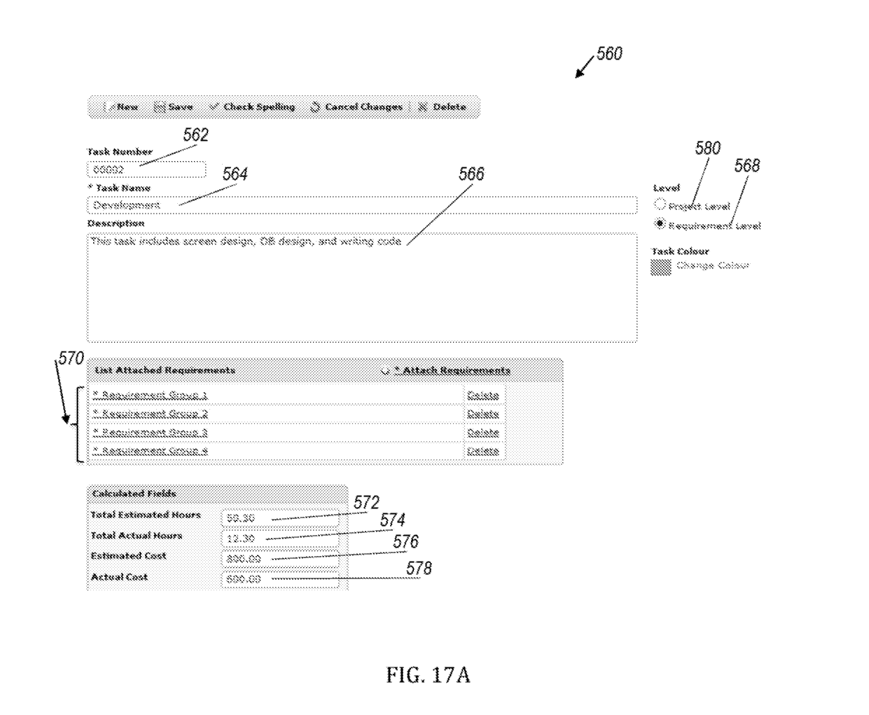

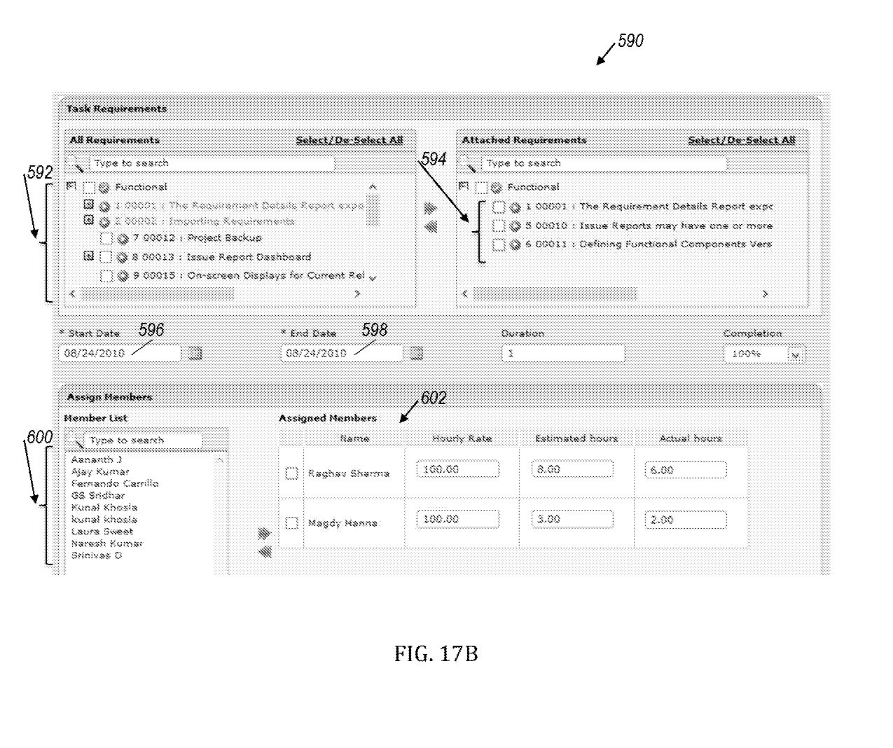

A user may use the interfaces 560 and 590 of FIGS. 17A and 17B, respectively, to define a task associated with a requirement, for example. The interface 560 of FIG. 17A provides fields for a task number 562, a task name 564, and a task description 566. As can be seen in FIG. 17A, the task is defined at the requirement level 568. A user can use the interface 590 of FIG. 17B to view a list of all of the requirements 592, and can select one or more requirements from the list to associate or attach the task to (e.g., three requirements 594 are selected in FIG. 17B). Additionally, a user can attach or associate a task with a group of requirements, and in FIG. 17A the task has been attached to four groups of requirements 570. A start date 596 and end date 598 may be assigned for the task, and team members 600 can be assigned to handle the task. Additionally, billing rate, estimated hours, and actual hours per assigned team member can be entered and tracked in an assigned members section 602 of interface 590.

Interface 560 of FIG. 17A illustrates that the tool 118 can calculate, by task at the requirement level, a total estimated hours amount 572, a total actual hours amount 574, an estimated cost amount 576, and an actual cost amount 578. In some implementations, associating tasks with requirements and providing these features may permit a user to better monitor status and progress of tasks with respect to specific requirements, which may permit the user to better assess the feasibility or likelihood that a particular release will be completed on schedule or within budget, for example. It may also permit a user to better monitor who is responsible for each task, the cost and time to perform each task, to estimate an impact of removing or adding a requirement to a release. In other examples, a task can be defined at the project level 580.

In some implementations, the software application lifecycle management tool 118 can provide cost estimates, whether in dollar amounts or time amounts, for requirements to be delivered with a release or iteration of a software application, and can provide a report that summarizes the cost estimates, by requirement. For example, the tool 118 may use the tasks associated with the requirements, as discussed above with reference to FIGS. 17A and 17B, to estimate the cost of a requirement by totaling the estimated cost of each of the tasks associated with the requirement.

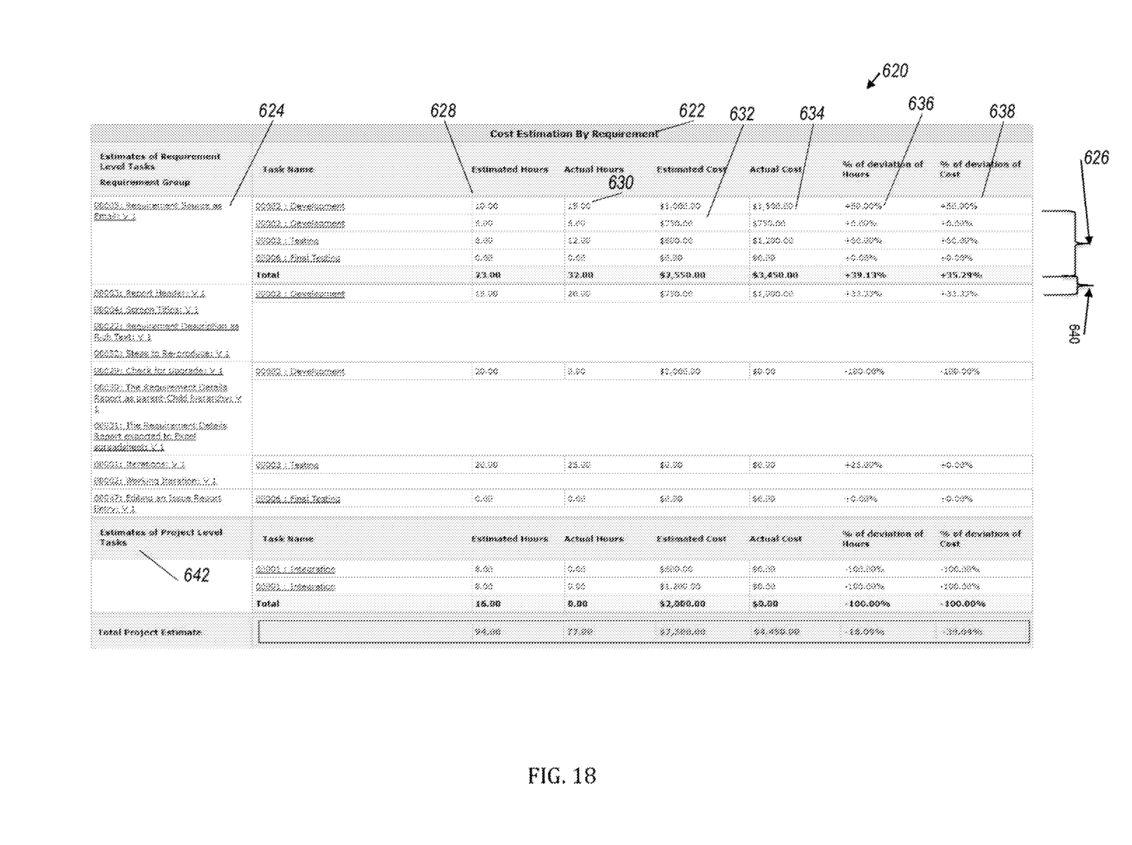

FIG. 18 is a screen shot of an example user interface 620 that may be presented on a display by the software application lifecycle management tool 118. The interface 620 includes a report 622 that summarizes cost estimates by requirement. The report 622 shows, for a given requirement 624, for example, the tasks 626 associated with the requirement 624, and columns of the report for estimated hours 628, actual hours 630, estimated cost 632, actual cost 634, % deviation of hours 636, and % deviation of cost 638 for each of the tasks (four tasks 626 shown associated with the requirement 624 in this example) associated with the requirement 624. A total cost 640 for the requirement 624 for each of the cost categories 628-638 is also provided. Cost estimates by project level are also provided in a project level section 642 of the report 622. In some examples, the report may also show cost estimates associated with one or more project-level tasks.

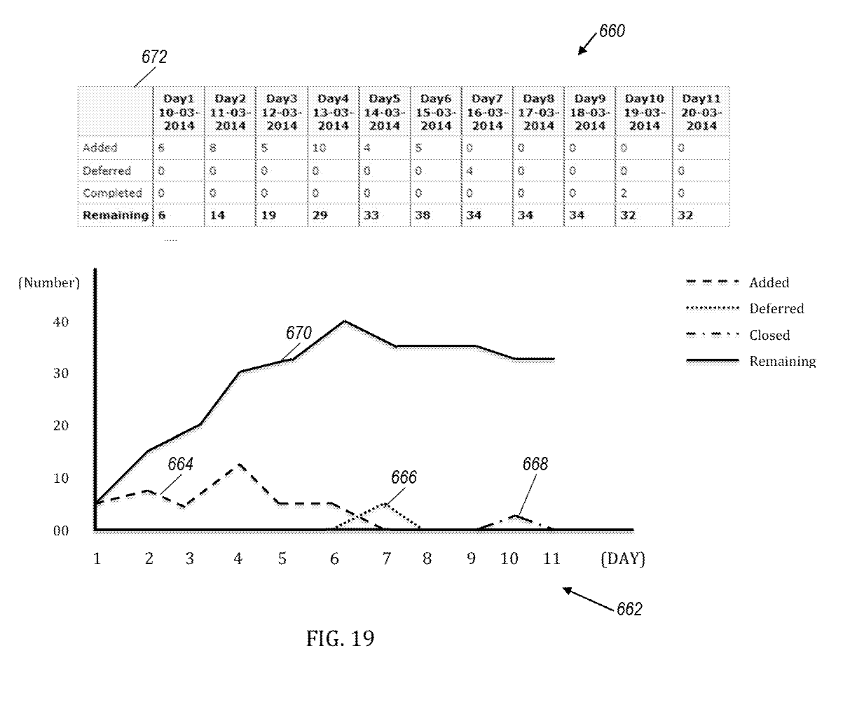

In some implementations, the software application lifecycle management tool 118 can provide a chart that shows, over one or more periods of time, indications of: i) a first number of predefined requirements of the software application that were added; ii) a second number of predefined requirements of the software application that were deferred; iii) a third number of predefined requirements of the software application that were completed; and iv) a fourth number of predefined requirements of the software application that remain to be completed. FIG. 19 is a screen shot of an example user interface 660 that may be presented on a display by the software application lifecycle management tool 118. Interface 660 includes a chart 662 that shows, over a period of time (eleven days in this example), a number of requirements that were added 664 to the project, a number of requirements that were deferred 666 from the project, a number of requirements that were completed 668 for the project, and a number of requirements that remain to be completed 670 for the project. Interface 660 also summarizes the information in a tabular form 672, in this example. In some examples, chart 662 can be presented without including tabular form 672, and in some examples tabular form 672 can be presented without including the chart 662.

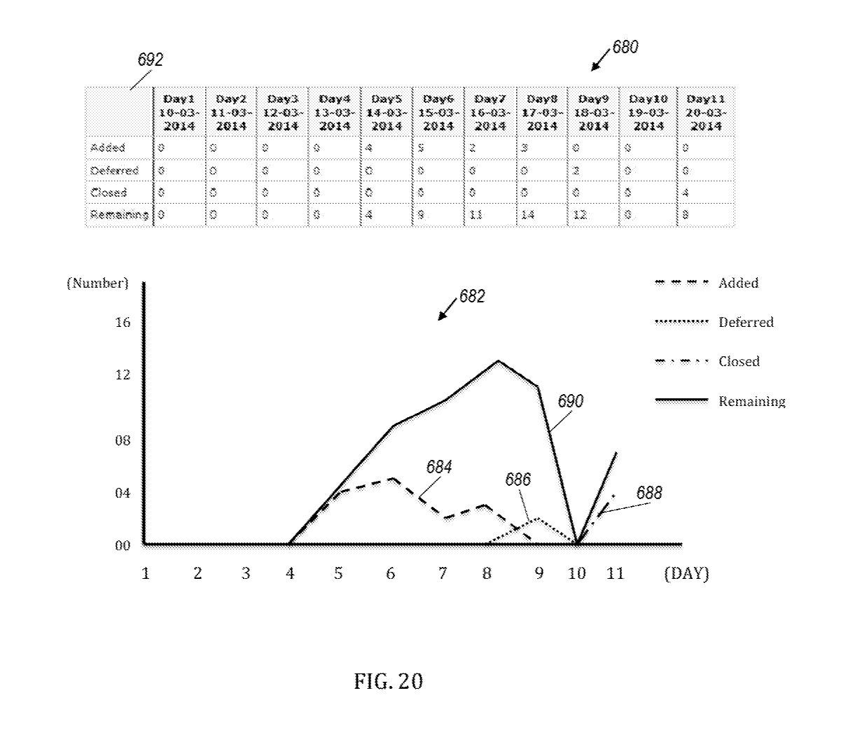

In some implementations, the software application lifecycle management tool 118 can also provide a chart that shows, over one or more periods of time, indications of: i) a first number of issues that were added; ii) a second number of issues that were deferred; iii) a third number of issues that were resolved; and iv) a fourth number of issues that remain. FIG. 20 is a screen shot of an example user interface 680 that may be presented on a display by the software application lifecycle management tool 118. Interface 680 includes a chart 682 that shows, over a period of time (eleven days in this example), a number of issues that were added 684 to the project, a number of issues that were deferred 686 from the project, a number of issues that were completed 688 for the project, and a number of issues that remain to be completed 690 for the project. Interface 680 also summarizes the information in a tabular form 692, in this example. In some examples, chart 682 can be presented without including tabular form 692, and in some examples tabular form 692 can be presented without including the chart 682.

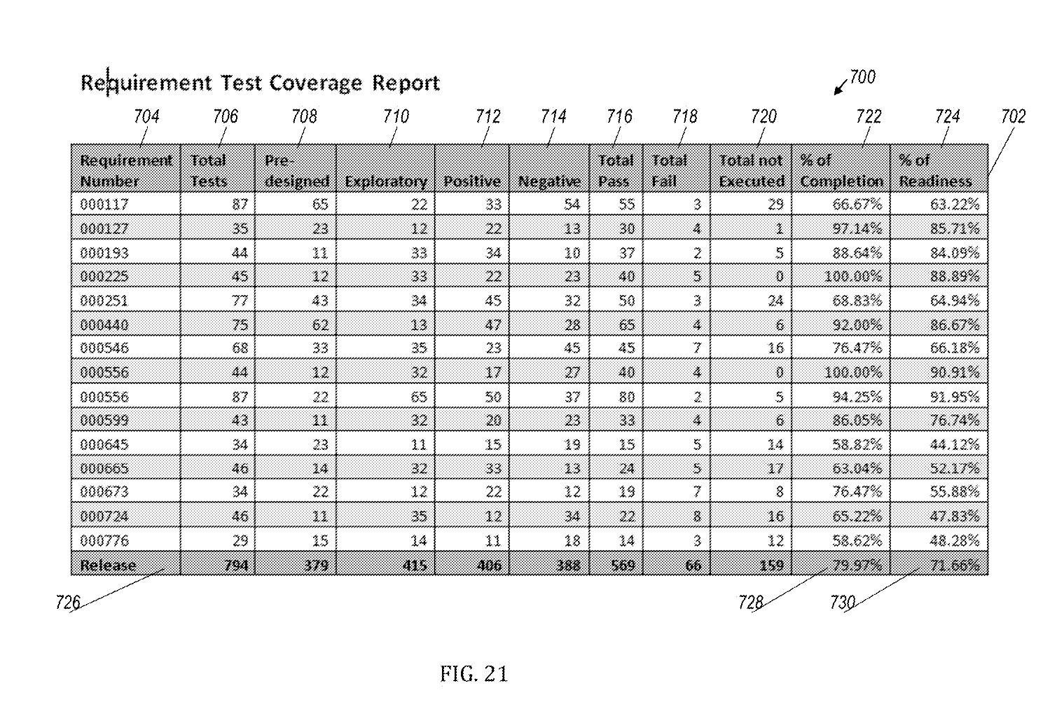

In some examples, the software application lifecycle management tool 118 can provide a report that shows a status of testing for one or more requirements of the project. FIG. 21 is an example report 700 that may be presented on a display by the software application lifecycle management tool 118. Interface 700 includes a matrix 702, where each row of the matrix corresponds to a requirement, and includes information or statistics related to the requirement or to testing of the requirement, for example. A requirement column 704 shows, for each row of the matrix, the requirement number corresponding to the requirement to which the information in the row pertains. A total tests column 706 shows the total number of tests that have been generated for a given requirement. In the depicted example, 87 total tests have been generated for requirement number 000117, for example.

In some examples, each test may be characterized as either a predesigned test or an exploratory (e.g., ad hoc) test, and a predesigned test column 708 and an exploratory test column 710 show the number of each type of test for a given requirement. In the depicted example, 65 of the 87 total tests for requirement number 000117 are predesigned tests, and 22 are exploratory tests, for example. In various implementations, test engineer or test manager may use the information in the matrix 702 to assess a level of maturity of the test design process. For example, the test design process may be considered more mature if a large number (e.g., a large absolute number or a large percentage of the total) of the total tests are predesigned tests, as opposed to exploratory tests. For requirement number 000440, for example, 62 of the 75 total tests are predesigned tests, and only 13 of the total tests are exploratory tests; for requirement number 000724, by contrast, only 11 of the 46 total tests are predesigned tests while 35 of the total tests are exploratory tests. As such, in some implementations the test design process for requirement 000440 may be considered more mature than the test design process for requirement 000724.

In some examples, each test may further be characterized as either a positive test or as a negative test, and a positive test column 712 and a negative test column 714 show the number of each type of test for a given requirement. In the depicted example, 33 of the 87 total tests for requirement number 000117 are positive tests, and 54 are negative tests, for example. As another measure of test design maturity, a test engineer or test manager may consider the number or percentage of negative tests for a given requirement, as compared to the number of positive tests for the requirement. In some examples, the test engineer or test manager may be looking for a sufficient number of negative tests, or that the number of negative tests is a sufficient percentage of the total tests, for example.

The matrix 702 additionally lists, by requirement, a number of tests that have passed, in a total pass column 716, a number of tests that have failed, in a total fail column 718, and a number of tests not yet executed, in a total not executed column 720. In the depicted example, 55 of the 87 total tests for requirement number 000117 have passed, 3 tests have failed, and 29 tests have not yet been executed, for example.

In various implementations, test engineer or test manager may use the information in the matrix 702 to assess a requirement's readiness for release. A Percentage of Completion column 722 shows, by requirement, a percentage of the total number of tests that have been executed (e.g., that have been executed and have either passed or failed). In some examples, the Percentage of Completion column 722 may provide the test engineer or test manager with an indication of how much testing remains to be done. In the depicted example, because 55 tests have passed and 3 tests have failed of the 87 total tests for requirement number 000117, while 29 tests have not yet been executed, the percentage of completion for requirement 000117 is 66.67% completed (58 of 87), and the tool 118 calculates this percentage value and presents it in the matrix.

A Percentage of Readiness column 724 shows, by requirement, a percentage of the total number of tests that have been executed and that have passed. In some examples, the Percentage of Readiness column 724 may provide the test engineer or test manager with an indication of how close the requirement is to being ready for release. In the depicted example, because 55 tests have passed and 32 tests have failed or have not yet been executed for requirement number 000117, the percentage of readiness for requirement 000117 is 63.22% (55 of 87), and the tool 118 calculates this percentage value and presents it in the matrix.

The matrix 702 also includes a Release row 726, for which the tool 118 aggregates the totals in each of the columns 706-720 for the requirements in the matrix, and based on the aggregate values calculates a percentage of completion value 728 and a percentage of readiness value 730 for the entire release. In the depicted example, the tool 118 has calculated that, at the project level, the testing is 79.97% complete (728) and 71.66% ready (730). In some examples, one or more (e.g., all) of the numbers in the matrix are hyperlinks that when selected cause the tool 118 to display additional detail (e.g., a list of test cases, by requirement, that have passed when a number in the column 716 is selected) on the corresponding number. In some examples, the interface 700 may include one or more charts (e.g., one or more pie charts) (not shown in FIG. 21) that depict statistics from the matrix 702 in a graphical format.

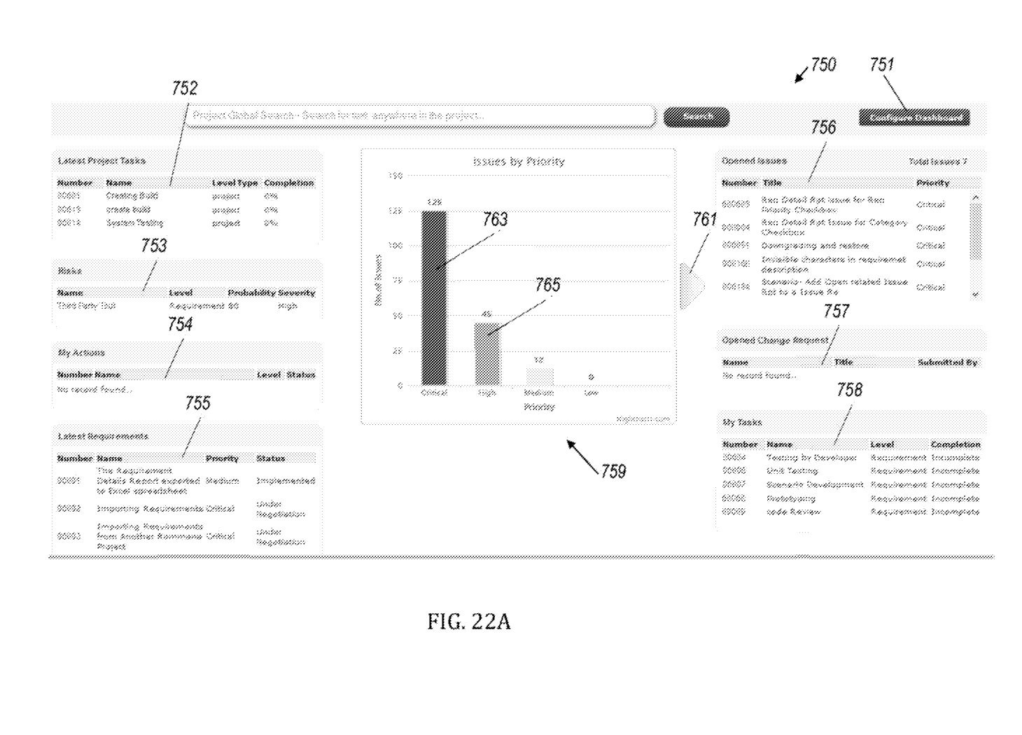

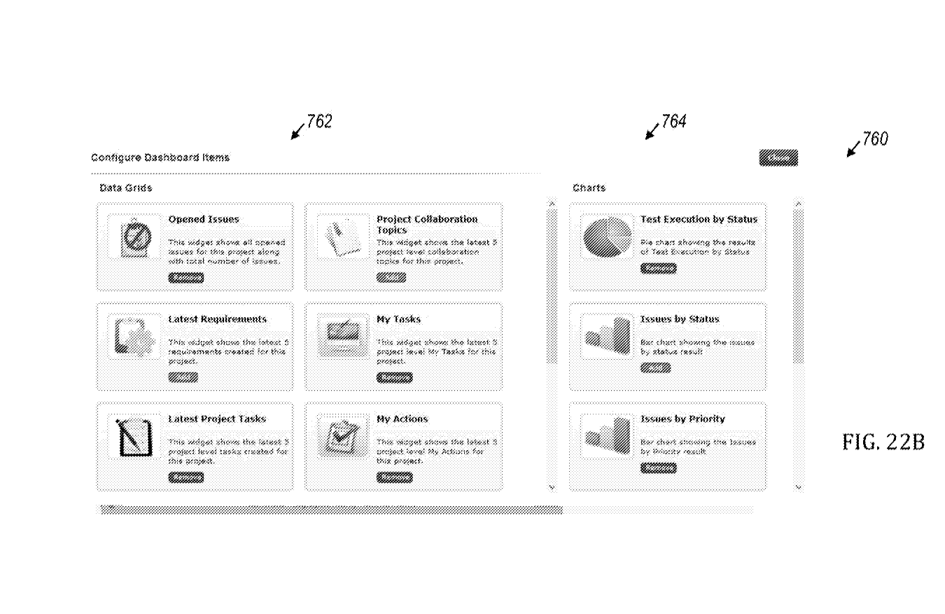

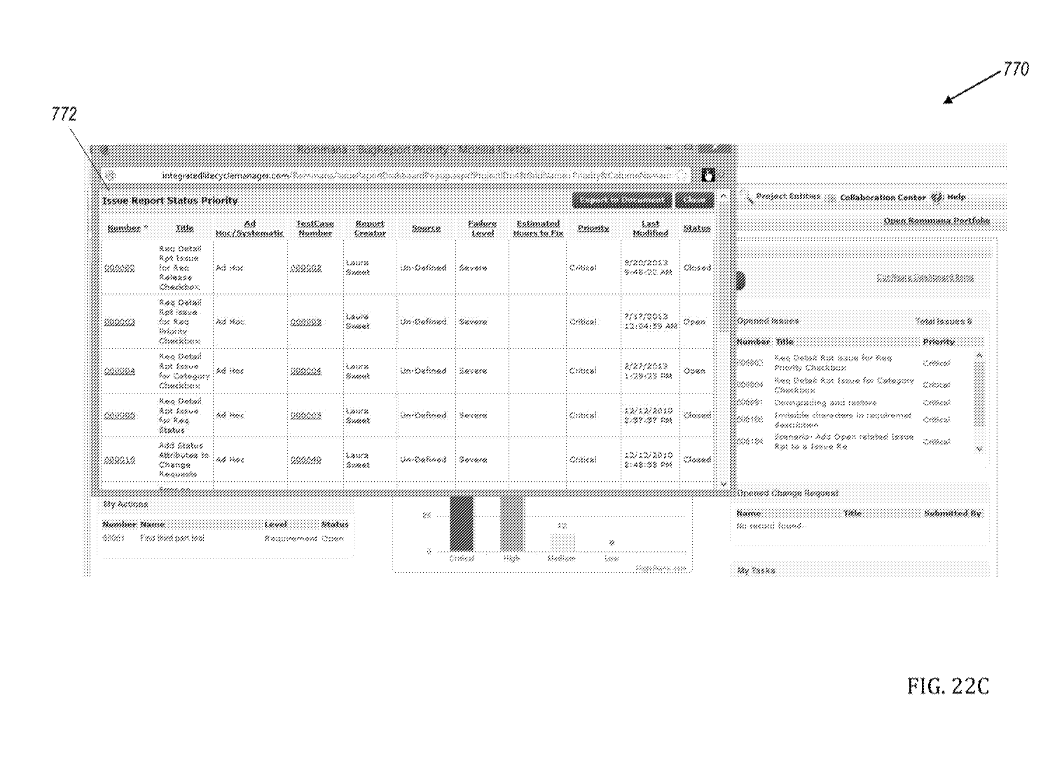

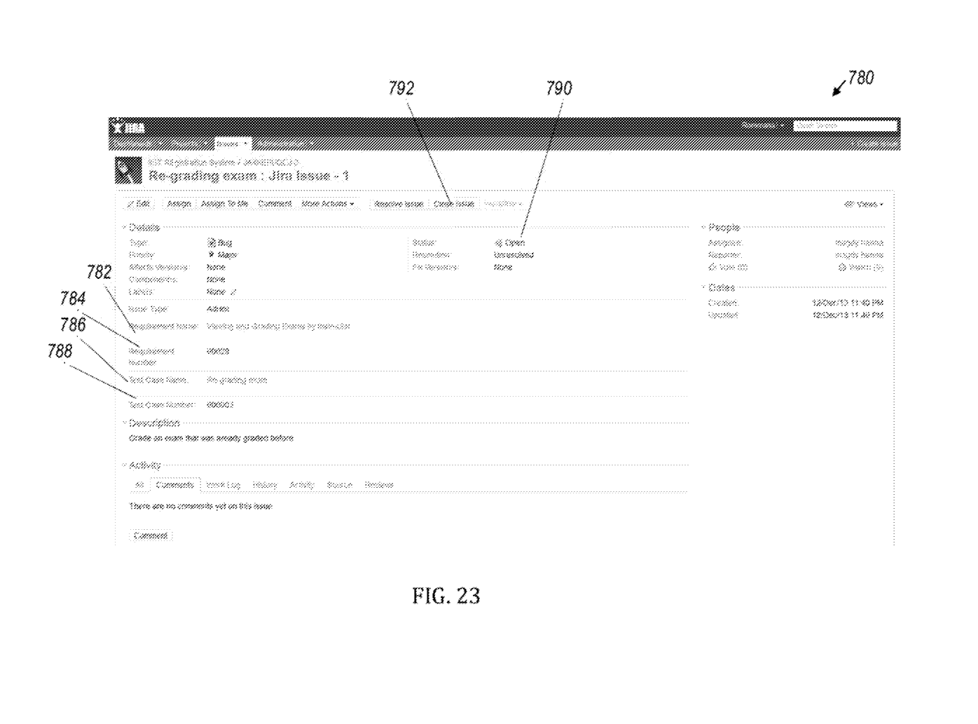

FIGS. 22A, 22B, and 22C are screen shots of example user interfaces 750, 760, and 770, respectively, that may be presented on a display by the software application lifecycle management tool 118. In some examples, the interface 750 of FIG. 22A represents a portion of a dashboard that a user may view when using the tool 118. The dashboard presents information associated with the project, and in some implementations may be configurable such that the dashboard displays various charts or tables (e.g., data grids) of interest to a user. For example, a user may select a “Configure Dashboard” button 751, and the tool 118 may present user interface 760 of FIG. 22B. Interface 760 permits the user to select which data grids or charts the user would like to view, or have viewable, in the dashboard interface 750 of FIG. 22A.

A “Data Grids” portion 762 of the interface 760 presents various data grid possibilities that the user may select (e.g., by clicking an associated “Add” button) or deselect (e.g., by clicking an associated “Remove” button), and the tool 118 may update the dashboard interface 750 in response to the user's selections. In this sense, the dashboard interface 750 of FIG. 22A may be considered dynamic or configurable because the user may select to see those data grids of most interest in the interface, and may select to remove from the dashboard interface 750 those data grids of comparatively lesser interest. Dashboard interface 750 of FIG. 22A shows a “Latest Project Tasks” table 752, a “Risks” table 753, a “My Actions” table 754, a “Latest Requirements” table 755, an “Opened Issues” table 756, an “Opened Change Request” table 757, and a “My Tasks” table 758. To populate the various tables 752-758 with data, the tool 118 pulls the data from a database associated with the tool, according to some implementations.

A “Charts” portion 764 of the interface 760 presents various chart possibilities that the user may select (e.g., by clicking an associated “Add” button) or deselect (e.g., by clicking an associated “Remove” button), and the tool 118 may update the dashboard interface 750 in response to the user's selections, and provide another dynamic or configurable aspect to the dashboard interface. Dashboard interface 750 of FIG. 22A shows a “Issues by Priority” chart 759, near the center of the interface 750. In some examples, a user may scroll through each of the selected charts sequentially by selecting an arrow 761. In the depicted example, arrow 761 is a right arrow, and in some examples a left arrow (not shown in FIG. 22A) may also be provided to permit the user to scroll in a second direction, for example. To populate the charts, the tool 118 pulls the data from the database, according to some implementations.

In some examples, the tool 118 may permit a user to “drill down” on some or all of the data presented in the dashboard interface 750. For example, when a user selects an item from the dashboard interface 750, the tool 118 may present a detailed representation of the selected item. The interface 770 of FIG. 22C shows a detail window 772, which may be presented when the user selects, for example, a bar 763 (the bar having “Critical” priority) of the chart 759 in interface 750 of FIG. 22A. The detail window 772 shows additional detail, in this example, for the issues having a “critical” priority, as indicated in a “Priority” column of the detail window 772. If the user were to alternatively select the bar 765 from the chart 759 having “High” priority, the tool 118 can present an alternative detail window with detailed information on those (45) issues having high priority, for example.

In some examples, the software application lifecycle management tool 118 may maintain bidirectional traceability between test cases within the tool 118 and one or more issue reports in one or more third-party issue report tools. Examples of third-party issue report, or bug report, tools include Bugzilla and Jira, each of which are software tools that can be used to present issue reports on a display screen for a user's review. In some examples, the software application lifecycle management tool 118 may maintain bidirectional traceability not only between test cases and issue reports, but also between one or more of scenarios, use cases, and requirements within the tool 118 and the one or more issue reports in the one or more third-party issue report tools. In some examples, the bidirectional traceability may permit the software application lifecycle management tool 118 to maintain a relationship between an entity (e.g., a test case, a requirement, a scenario, a use case) within the tool 118 and an issue report in a third-party tool that describes, for example, a failure of the entity.

FIG. 23 is a screen shot of an example user interface 780. Interface 780 may be presented in Jira. The interface 780 includes a requirement name 782, a requirement number 784, a test case name 786, and a test case number 788, each of which correspond to entities within the software application lifecycle management tool 118. In various implementations, a connection may be configured between the software application lifecycle management tool 118 and the third-party tool (Jira in this case), and one or more custom attributes may be created in the third-party tool to hold an attribute of the entity in the software application lifecycle management tool 118, for display in the third-party tool, for example as shown with values 782-788.

As can be seen in FIG. 23, a status 790 of the issue is currently “Open,” which may indicate that the corresponding test case (having number “000003” (788), and name “Re-grading exam” (786)) for the corresponding requirement (having number “00029” (782) and name “Re-grading exam” (784)) has a failed status. If, for example, a user attempted to select a “Close Issue” button 792, the software application lifecycle management tool 118 would, after receiving an indication of the attempt to close the issue, communicate with the third-party tool to prevent the closing of the issue, and an error message can be displayed to inform the user that the requested action is not permitted. In various implementations, attempting to close an issue report pertaining to a failed test case may be done accidentally or without untoward intent, or in some cases may be done knowingly, for example in an attempt to avoid scrutiny or “cover up” a non-passing test case. In the described example, the user could first go into the software application lifecycle management tool 118 and change the status of the test case to “pass,” and then close the issue in the third-party tool, for example. The bidirectional traceability feature, by providing a tighter integration between the tool 118 and third-party issue report tools, may thus improve the testing process by preventing closure of issue reports when such issue reports should not be closed because the associated test case has not yet successfully passed, according to some implementations.

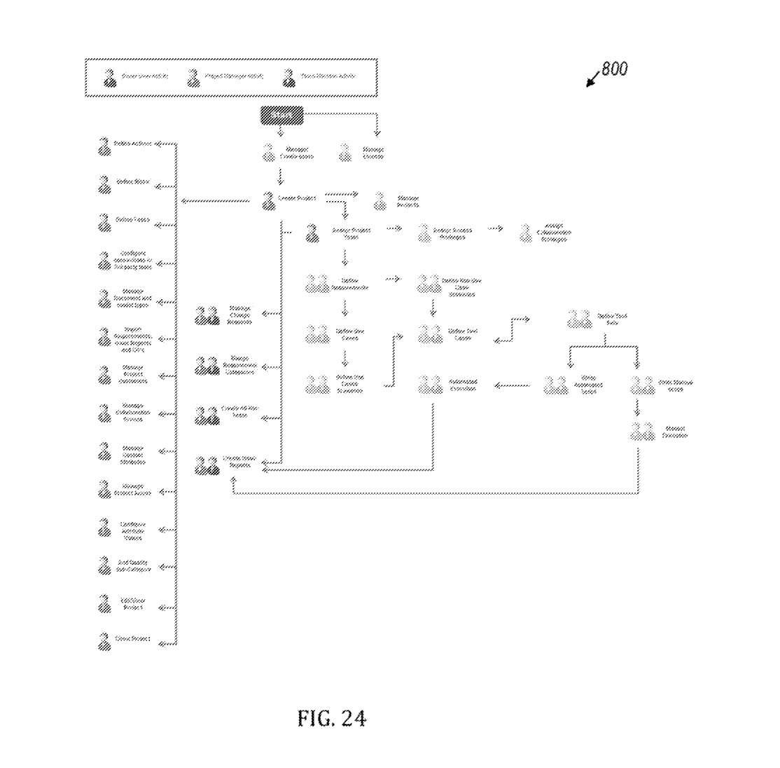

FIG. 24 is a screen shot of an example user interface 800 that may be presented on a display by the software application lifecycle management tool 118. The example user interface 800 shows various project activities, indicated by a description (e.g., “Assign Project Team,” “Define Requirements,” “Define Test Cases”), and includes arrows between certain activities that may indicate a permitted workflow path order for the activities. To work on an activity, a user may select an activity, for example. In some examples, activities that are not yet ready to be worked on (e.g., because a prerequisite activity has not yet been completed) may be non-selectable (e.g., “grayed out” or otherwise visually indicated as not selectable). In some examples, one or more icons may be associated with and displayed with the activity description to indicate which team member (or role or title) is permitted to perform the activity.

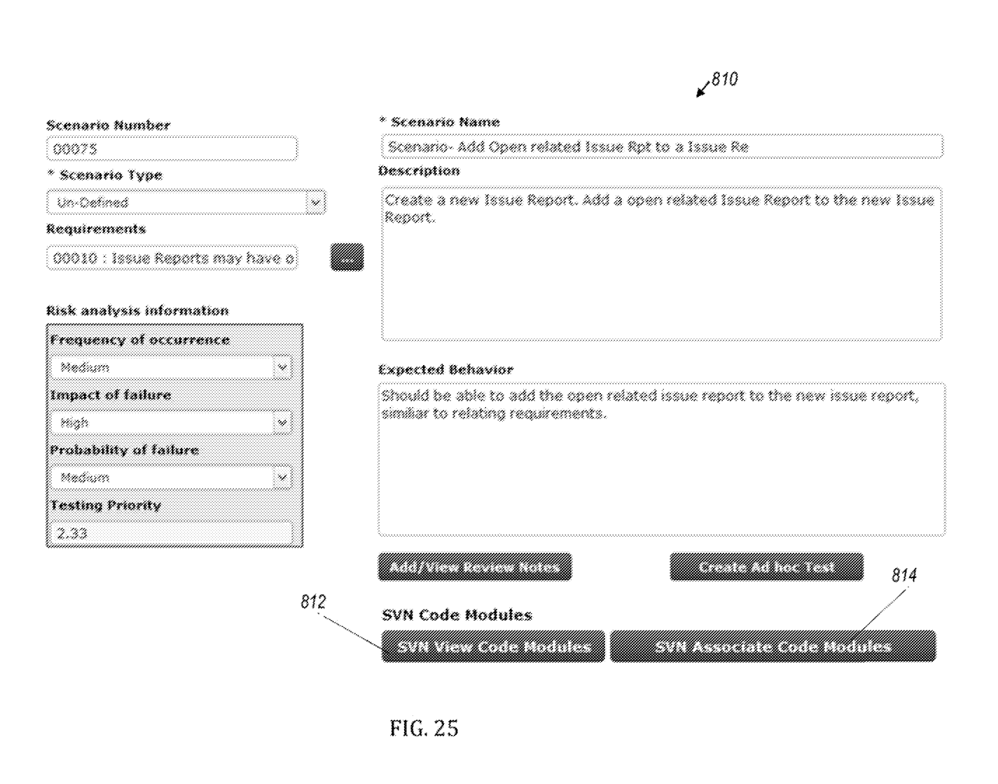

In some examples, the software application lifecycle management tool 118 provides bidirectional mapping between a scenario and development code components written to implement the scenario. This may permit a user to easily see development code written (e.g., by a development engineer) to implement a scenario, and may be used to verify that the scenario has been considered, implemented and accounted for in the development code. In this manner, a user may check to verify that all scenarios have been implemented in development code, for example. Similarly, the feature may be used in the opposite direction to verify, for example, that all development code components correspond to one or more scenarios. FIG. 25 is a screen shot of an example user interface 810 that may be presented on a display by the software application lifecycle management tool 118. For the depicted scenario (having number 00075 in this example), a user may select a view code button 812, and the tool 118 may display the development code associated with the scenario. As an initial step, the development engineer may associate the development code components with the scenario by selecting an associate code button 814, which may cause the tool 118 to associate the development code component with the scenario.

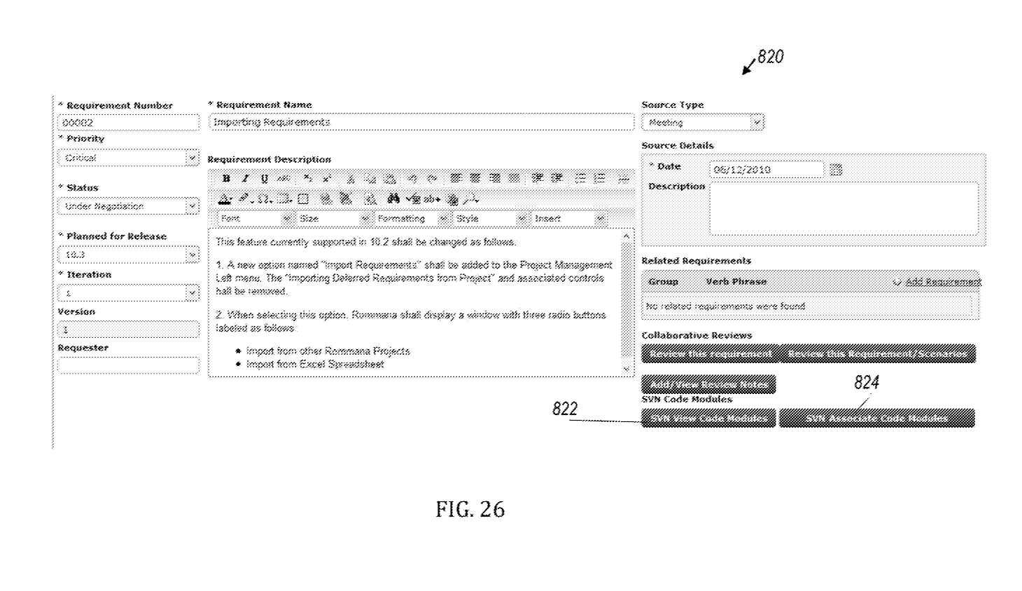

In some examples, the software application lifecycle management tool 118 provides bidirectional mapping between a requirement and development code components written to implement the requirement. This may permit a user to easily see development code written (e.g., by a development engineer) to implement a requirement, and may be used to verify that the requirement has been considered, implemented and accounted for in the development code. In this manner, a user may check to verify that all requirements have been implemented in development code, for example. Similarly, the feature may be used in the opposite direction to verify, for example, that all development code components correspond to one or more requirements. FIG. 26 is a screen shot of an example user interface 820 that may be presented on a display by the software application lifecycle management tool 118. For the depicted requirement (having number 00002 in this example), a user may select a view code button 822, and the tool 118 may display the development code associated with the requirement. As an initial step, the development engineer may associate the development code components with the requirement by selecting an associate code button 824, which may cause the tool 118 to associate the development code component with the requirement.

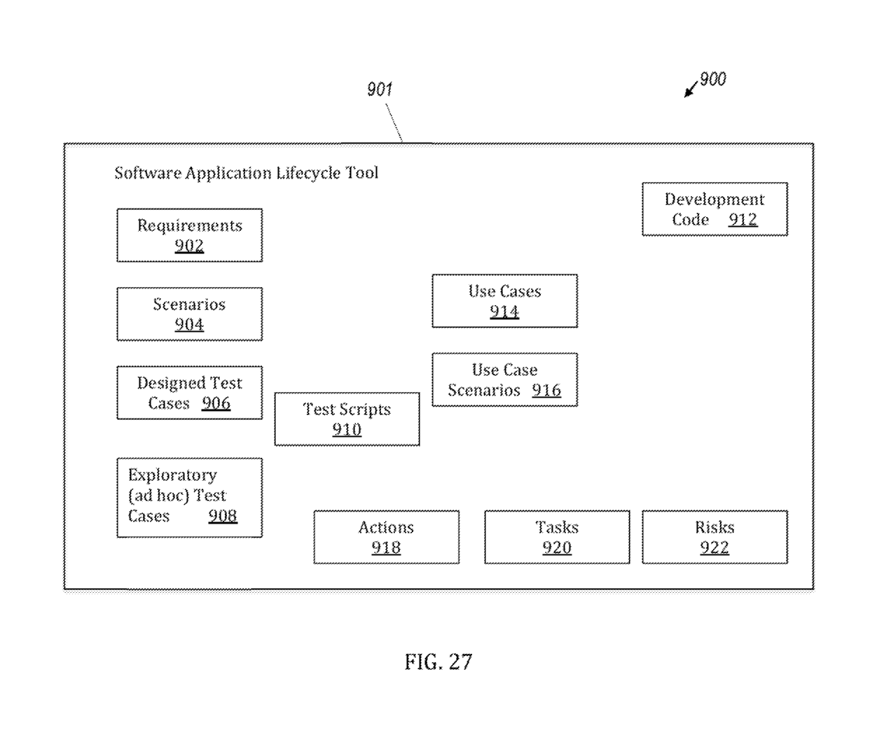

FIG. 27 is a block diagram 900 of an example software application lifecycle tool 901. In some examples, tool 901 may correspond to the software application lifecycle tool 118 of FIG. 1. The example software application lifecycle tool 901 includes requirements 902, which in various implementations may be generated or created within the tool 901, or may be imported into the tool 901 (e.g., from another application, such as a word processing application or a spreadsheet application). The software application lifecycle tool 901 also includes scenarios 904, which may be generated or created using the tool 901. The software application lifecycle tool 901 further includes test cases, such as predesigned test cases 906 and exploratory test cases 908. The test cases may be generated or created using the tool 901, for example. The software application lifecycle tool 901 further includes test scripts 910, may be generated or created using the tool 901, for example. In this example, the software application lifecycle tool 901 includes development code 912. In some implementations, development code is created and maintained in a separate application outside of the tool 901. The software application lifecycle tool 901 further includes use cases 914 and use case scenarios 916, each of which may be generated or created using the tool 901, for example. The software application lifecycle tool 901 further includes actions 918, tasks 920, and risks 922, each of which may be generated or created using the tool 901, for example.

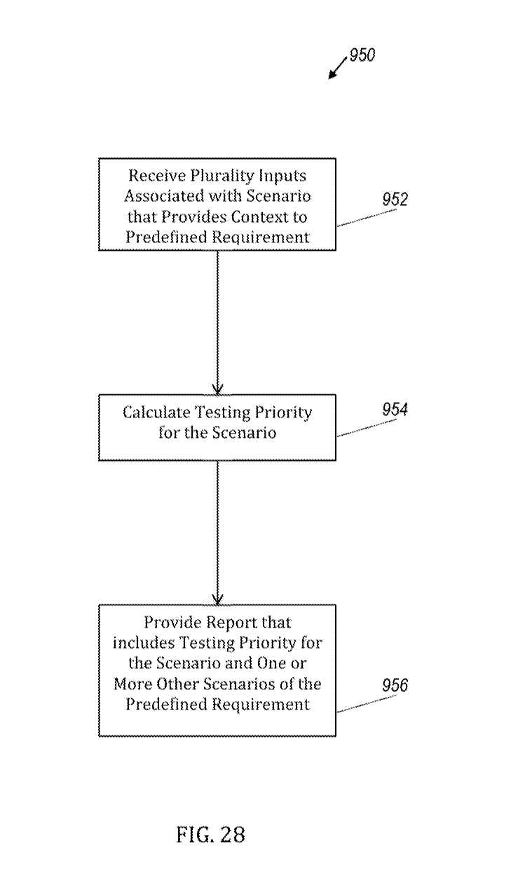

FIG. 28 is a flowchart of an example method 950 that may be performed by a software application lifecycle management tool. At a first step 952, a plurality of inputs associated with a scenario that provides a context for a predefined requirement is received. The predefined requirement may be a requirement of a software application, and the inputs may be received in association with the predefined requirement. The plurality of inputs may include: i) a scenario name; ii) a scenario description; iii) a scenario expected behavior; iv) an indicator of a likelihood of the scenario occurring; v) an indicator of an impact of a failure of the scenario; and vi) an indicator of a probability of the failure of the scenario occurring.

A testing priority for the scenario is calculated at step 954. The testing priority may be calculated by a computation unit based on the indicator of the likelihood of the scenario occurring, the indicator of the impact of the failure of the scenario, and the indicator of the probability of the failure of the scenario occurring. Calculating the testing priority can include, in some examples, associating a first numerical value with the indicator of the likelihood of the scenario occurring, associating a second numerical value with the indicator of the impact of the failure of the scenario, and associating a third numerical value with the indicator of the probability of the failure of the scenario occurring, and computing an average value of the first numerical value, second numerical value, and third numerical value. A report that includes the testing priority for the scenario and one or more other testing priorities for one or more other scenarios of the predefined requirement is provided at step 956.

Computing devices and computer systems described in this document that may be used to implement the systems, techniques, machines, and/or apparatuses can operate as clients and/or servers, and can include one or more of a variety of appropriate computing devices, such as laptops, desktops, workstations, servers, blade servers, mainframes, mobile computing devices (e.g., PDAs, cellular telephones, smartphones, and/or other similar computing devices), computer storage devices (e.g., Universal Serial Bus (USB) flash drives, RFID storage devices, solid state hard drives, hard-disc storage devices), and/or other similar computing devices. For example, USB flash drives may store operating systems and other applications, and can include input/output components, such as wireless transmitters and/or USB connector that may be inserted into a USB port of another computing device.

Such computing devices may include one or more of the following components: processors, memory (e.g., random access memory (RAM) and/or other forms of volatile memory), storage devices (e.g., solid-state hard drive, hard disc drive, and/or other forms of non-volatile memory), high-speed interfaces connecting various components to each other (e.g., connecting one or more processors to memory and/or to high-speed expansion ports), and/or low speed interfaces connecting various components to each other (e.g., connecting one or more processors to a low speed bus and/or storage devices). Such components can be interconnected using various busses, and may be mounted across one or more motherboards that are communicatively connected to each other, or in other appropriate manners. In some implementations, computing devices can include pluralities of the components listed above, including a plurality of processors, a plurality of memories, a plurality of types of memories, a plurality of storage devices, and/or a plurality of buses. A plurality of computing devices can be connected to each other and can coordinate at least a portion of their computing resources to perform one or more operations, such as providing a multi-processor computer system, a computer server system, and/or a cloud-based computer system.

Processors can process instructions for execution within computing devices, including instructions stored in memory and/or on storage devices. Such processing of instructions can cause various operations to be performed, including causing visual, audible, and/or haptic information to be output by one or more input/output devices, such as a display that is configured to output graphical information, such as a graphical user interface (GUI). Processors can be implemented as a chipset of chips that include separate and/or multiple analog and digital processors. Processors may be implemented using any of a number of architectures, such as a CISC (Complex Instruction Set Computers) processor architecture, a RISC (Reduced Instruction Set Computer) processor architecture, and/or a MISC (Minimal Instruction Set Computer) processor architecture. Processors may provide, for example, coordination of other components computing devices, such as control of user interfaces, applications that are run by the devices, and wireless communication by the devices.

Memory can store information within computing devices, including instructions to be executed by one or more processors. Memory can include a volatile memory unit or units, such as synchronous RAM (e.g., double data rate synchronous dynamic random access memory (DDR SDRAM), DDR2 SDRAM, DDR3 SDRAM, DDR4 SDRAM), asynchronous RAM (e.g., fast page mode dynamic RAM (FPM DRAM), extended data out DRAM (EDO DRAM)), graphics RAM (e.g., graphics DDR4 (GDDR4), GDDR5). In some implementations, memory can include a non-volatile memory unit or units (e.g., flash memory). Memory can also be another form of computer-readable medium, such as magnetic and/or optical disks.

Storage devices can be capable of providing mass storage for computing devices and can include a computer-readable medium, such as a floppy disk device, a hard disk device, an optical disk device, a Microdrive, or a tape device, a flash memory or other similar solid state memory device, or an array of devices, including devices in a storage area network or other configurations. Computer program products can be tangibly embodied in an information carrier, such as memory, storage devices, cache memory within a processor, and/or other appropriate computer-readable medium. Computer program products may also contain instructions that, when executed by one or more computing devices, perform one or more methods or techniques, such as those described above.

High speed controllers can manage bandwidth-intensive operations for computing devices, while the low speed controllers can manage lower bandwidth-intensive operations. Such allocation of functions is exemplary only. In some implementations, a high-speed controller is coupled to memory, display (e.g., through a graphics processor or accelerator), and to high-speed expansion ports, which may accept various expansion cards; and a low-speed controller is coupled to one or more storage devices and low-speed expansion ports, which may include various communication ports (e.g., USB, Bluetooth, Ethernet, wireless Ethernet) that may be coupled to one or more input/output devices, such as keyboards, pointing devices (e.g., mouse, touchpad, track ball), printers, scanners, copiers, digital cameras, microphones, displays, haptic devices, and/or networking devices such as switches and/or routers (e.g., through a network adapter).

Displays may include any of a variety of appropriate display devices, such as TFT (Thin-Film-Transistor Liquid Crystal Display) displays, OLED (Organic Light Emitting Diode) displays, touchscreen devices, presence sensing display devices, and/or other appropriate display technology. Displays can be coupled to appropriate circuitry for driving the displays to output graphical and other information to a user.

Expansion memory may also be provided and connected to computing devices through one or more expansion interfaces, which may include, for example, a SIMM (Single In Line Memory Module) card interfaces. Such expansion memory may provide extra storage space for computing devices and/or may store applications or other information that is accessible by computing devices. For example, expansion memory may include instructions to carry out and/or supplement the techniques described above, and/or may include secure information (e.g., expansion memory may include a security module and may be programmed with instructions that permit secure use on a computing device).

Computing devices may communicate wirelessly through one or more communication interfaces, which may include digital signal processing circuitry when appropriate. Communication interfaces may provide for communications under various modes or protocols, such as GSM voice calls, messaging protocols (e.g., SMS, EMS, or MMS messaging), CDMA, TDMA, PDC, WCDMA, CDMA2000, GPRS, 4G protocols (e.g., 4G LTE), and/or other appropriate protocols. Such communication may occur, for example, through one or more radio-frequency transceivers. In addition, short-range communication may occur, such as using a Bluetooth, Wi-Fi, or other such transceivers.

Computing devices may also communicate audibly using one or more audio codecs, which may receive spoken information from a user and convert it to usable digital information. Such audio codecs may additionally generate audible sound for a user, such as through one or more speakers that are part of or connected to a computing device. Such sound may include sound from voice telephone calls, may include recorded sound (e.g., voice messages, music files, etc.), and may also include sound generated by applications operating on computing devices.

Various implementations of the systems, devices, and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, or code) can include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor.

To provide for interaction with a user, the systems and techniques described here can be implemented on a computer having a display device (e.g., LCD display screen, LED display screen) for displaying information to users, a keyboard, and a pointing device (e.g., a mouse, a trackball, touchscreen) by which the user can provide input to the computer. Other kinds of devices can be used to provide for interaction with a user as well; for example, feedback provided to the user can be any form of sensory feedback (e.g., visual feedback, auditory feedback, and/or tactile feedback); and input from the user can be received in any form, including acoustic, speech, and/or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), peer-to-peer networks (having ad-hoc or static members), grid computing infrastructures, and the Internet.

The computing system can include clients and servers. A client and server are generally remote from each other and typically interact through a communication network. The relationship of client and server arises by virtue of computer programs running on the respective computers and having a client-server relationship to each other.

The above description provides examples of some implementations. Other implementations that are not explicitly described above are also possible, such as implementations based on modifications and/or variations of the features described above. For example, the techniques described above may be implemented in different orders, with the inclusion of one or more additional steps, and/or with the exclusion of one or more of the identified steps. Additionally, the steps and techniques described above as being performed by some computing devices and/or systems may alternatively, or additionally, be performed by other computing devices and/or systems that are described above or other computing devices and/or systems that are not explicitly described. Similarly, the systems, devices, and apparatuses may include one or more additional features, may exclude one or more of the identified features, and/or include the identified features combined in a different way than presented above. Features that are described as singular may be implemented as a plurality of such features. Likewise, features that are described as a plurality may be implemented as singular instances of such features. The drawings are intended to be illustrative and may not precisely depict some implementations. Variations in sizing, placement, shapes, angles, and/or the positioning of features relative to each other are possible.

What is claimed is:

1. A computer-implemented method for software application lifecycle management, comprising:
receiving, in association with a predefined requirement of a software application, a plurality of inputs associated with a scenario that provides a context for the predefined requirement, the plurality of inputs comprising: i) a scenario name; ii) a scenario description; iii) a scenario expected behavior; iv) an indicator of a likelihood of the scenario occurring; v) an indicator of an impact of a failure of the scenario; and vi) an indicator of a probability of the failure of the scenario occurring;
calculating, at a computation unit, a testing priority for the scenario based on the indicator of the likelihood of the scenario occurring, the indicator of the impact of the failure of the scenario, and the indicator of the probability of the failure of the scenario occurring; and
providing a report that includes the testing priority for the scenario and one or more other testing priorities for one or more other scenarios of the predefined requirement.

2. The computer-implemented method of claim 1, wherein the calculating the testing priority for the scenario comprises associating a first numerical value with the indicator of the likelihood of the scenario occurring, associating a second numerical value with the indicator of the impact of the failure of the scenario, and associating a third numerical value with the indicator of the probability of the failure of the scenario occurring, and computing an average value of the first numerical value, second numerical value, and third numerical value.

3. The computer-implemented method of claim 1, further comprising distributing, via an electronic communication, the scenario name, the scenario description, and the scenario expected behavior to one or more users and soliciting one or more responses from the one or more users.

4. The computer-implemented method of claim 1, further comprising creating a first test case for the scenario, the first test case comprising one or more first test case inputs, one or more first test case pre-conditions, one or more first test case outputs, and one or more first test case post-conditions.

5. The computer-implemented method of claim 4, wherein the first test case is an exploratory test case that is automatically created by assigning the scenario name to an exploratory test case name, assigning the scenario description to an exploratory test case description, assigning the scenario expected behavior to an exploratory test case expected behavior, and providing a test case pass/fail attribute.

6. The computer-implemented method of claim 5, further comprising creating a second exploratory test case for the scenario based on the first test case.

7. The computer-implemented method of claim 4, further comprising creating a second test case for the scenario, wherein creating the second test case comprises presenting one or more of the first test case inputs and one or more of the first test case pre-conditions, and receiving one or more second test case inputs or pre-conditions that are different from the one or more first test case inputs or pre-conditions, respectively, and receiving one or more second test case outputs or post-conditions that are different from the one or more first test case outputs or post-conditions, respectively.

8. The computer-implemented method of claim 4, further comprising creating a third test case for the scenario that is a negative version of the first test case.

9. The computer-implemented method of claim 4, wherein the predefined requirement is associated with one or more objects selected from the group consisting of a scenario, a use case, a model, and a test case, and further comprising creating a second version of the predefined requirement of the software application in response to an approved change request for the predefined requirement of the software application, the second version associated with one or more of the objects.

10. The computer-implemented method of claim 1, further comprising associating a model with the predefined requirement, the model selected from the group consisting of a data model, a process model, an object model, a state model, a user interface model, a decision tree, a decision table, and a use case.

11. The computer-implemented method of claim 1, further comprising importing the predefined requirement from a word processing application or from a spreadsheet application.

12. The computer-implemented method of claim 1, wherein the predefined requirement pertains to a quality aspect of the software application, and further comprising creating a subcategory of the predefined requirement that pertains to the quality aspect.

13. The computer-implemented method of claim 1, further comprising associating a task with the predefined requirement, wherein the task includes a task duration, a task start date, and a task end date.

14. The computer-implemented method of claim 13, further comprising providing a graphical representation that shows, for each predefined requirement of a plurality of predefined requirements of the software application, one or more tasks associated with the corresponding predefined requirement, one or more durations for each of the one or more tasks, and an indication of who will perform each of the one or more tasks.

15. The computer-implemented method of claim 1, further comprising associating an action or a risk with the predefined requirement.

16. The computer-implemented method of claim 1, further comprising providing a report that includes, for the predefined requirement: i) an indication of a percentage of tests that have been completed, and ii) an indication of a percentage of tests that have passed.

17. The computer-implemented method of claim 1, wherein the predefined requirement is associated with a plurality of tasks, and further comprising estimating a cost of the predefined requirement, including computing a cost estimate for each task of the associated plurality of tasks, and further comprising providing a report that includes the estimated cost of the predefined requirement and the cost estimate for each task.

18. The computer-implemented method of claim 1, further comprising providing a chart that shows, over one or more periods of time, indications of: i) a first number of predefined requirements of the software application that were added; ii) a second number of predefined requirements of the software application that were deferred; iii) a third number of predefined requirements of the software application that were completed; and iv) a fourth number of predefined requirements of the software application that remain to be completed.

19. The computer-implemented method of claim 1, further comprising providing a chart that shows, over one or more periods of time, indications of: i) a first number of issues that were added; ii) a second number of issues that were deferred; iii) a third number of issues that were resolved; and iv) and a fourth number of issues that remain.

20. The computer-implemented method of claim 1, further comprising providing a user interface that is configurable by a user to display data grids or charts selected by the user.

21. The computer-implemented method of claim 1, further comprising providing bidirectional traceability with a third-party issue report software tool.

22. The computer-implemented method of claim 1, further comprising providing a user interface that includes a plurality of project activities, wherein the user interface specifies a workflow of the project activities.

23. The computer-implemented method of claim 1, further comprising displaying development code constructs associated with the predefined requirement or with the scenario.

24. A computer program product tangibly embodied on a non-transitory computer-readable medium storing instructions that, when executed, cause one or more processors to perform operations comprising:
receive, in association with a predefined requirement of a software application, a plurality of inputs associated with a scenario that provides a context for the predefined requirement, the plurality of inputs comprising: i) a scenario name; ii) a scenario description; iii) a scenario expected behavior; iv) an indicator of a likelihood of the scenario occurring; v) an indicator of an impact of a failure of the scenario; and vi) an indicator of a probability of the failure of the scenario occurring;
calculate a testing priority for the scenario based on the indicator of the likelihood of the scenario occurring, the indicator of the impact of the failure of the scenario, and the indicator of the probability of the failure of the scenario occurring; and
provide a report that includes the testing priority for the scenario and one or more testing priorities for one or more other scenarios of the predefined requirement.
